(19) United States
(12) Patent Application Publication
(10) Pub. No.: US 2026/0189376 A1
(43) Pub. Date: Jul. 2, 2026

(54) CONTINUOUS VARIABLE QUANTUM KEY DISTRIBUTION SYSTEM AND METHOD

(71) Applicant: Huawei Technologies Duesseldorf GmbH, Duesseldorf (DE)

(72) Inventors: Fred Chi Hang Fung, Munich (DE); Hans Brunner, Munich (DE)

(21) Appl. No.: 19/551,900

(22) Filed: Feb. 27, 2026

Related U.S. Application Data
(63) Continuation of application No. PCT/EP2023/081121, filed on Nov. 8, 2023.

(30) Foreign Application Priority Data
Aug. 30, 2023 (DE) 102023004199.8

(51) Int. Cl. H04L 9/08

(52) U.S. Cl. CPC H04L 9/0852

(57) ABSTRACT

A CV-QKD system comprising a plurality of transmitters, one or more splitters, and a plurality of receivers is provided. Each transmitter modulates a quantum signal according to a discrete or continuous distribution in phase and amplitude. Each splitter distributes N modulated quantum signals, received from a respective transmitter or from another splitter, into M modulated quantum sub-signals. Each receiver is configured to: receive, via a respective quantum channel, a modulated quantum sub-signal associated to one or more of the transmitters from the one or more splitters; detect one or more quadrature components of the received modulated quantum sub-signal; and perform a respective post-processing protocol with one or more of the plurality of transmitters to generate one or more individual final secret keys between the one or more transmitters and the receiver and/or one or more common secret keys between the one or more transmitters and the plurality of receivers.

### CROSS-REFERENCE TO RELATED APPLICATIONS

This application is a continuation of International Application No. PCT/EP2023/081121, filed on Nov. 8, 2023, which claims priority to German Patent Application No. DE 102023004199.8, filed on Aug. 30, 2023. The disclosures of the aforementioned applications are hereby incorporated by reference in their entireties.

### TECHNICAL FIELD

This disclosure relates to the field of Quantum Key Distribution (QKD). The disclosure provides a continuous variable-Quantum Key Distribution (CV-QKD) system and method to generate one or more individual secret keys between pairs of parties of the CV-QKD system and/or one or more common secret keys among multi-parties of the CV-QKD system. The disclosure also relates to an optical network comprising the CV-QKD system, and computer program to perform the method.

### BACKGROUND

QKD protocols are methods for generating secret keys based on quantum physics. The generated keys are information-theoretically secure, in contrast to computational security offered by conventional cryptographic methods.

There are two main types of QKD protocols adopted in practical QKD systems: discrete-variable (DV) based and continuous-variable (CV) based. In DV-QKD, the secure bits are derived from information carried in single photons. In CV-QKD, the secure bits are derived from information carried in the quadratures of the quantized electromagnetic wave.

DV-QKD and CV-QKD systems rely on different detection technologies for implementation. DV-QKD requires specialized single-photon detectors, as opposed to coherent detectors used CV-QKD, and a separate synchronization channel that may occupy a different wavelength or a different fiber, while lab experiments of DV-QKD have been shown to achieve long distances.

QKD systems implement QKD protocols in which a classical post-processing transforms initial correlated data between Alice and Bob, which is generated by transmitting and measuring quantum states, to perfect and secure data (i.e., the final key). This post-processing part usually includes at least a parameter estimation step, an information reconciliation step and a privacy amplification step. However, in general, in order to maintain certain level of security of the final key, data sets operated in the post-processing have large block lengths, particularly in the privacy amplification step. Reduction to small block lengths would be desirable, in view of saving storage space and reducing latency.

QKD systems are conventionally deployed as point-to-point links. In particular, each link is composed of a sender (Alice) and a receiver (Bob) and they are usually connected by an optical fiber cable. When QKD systems are deployed to form a QKD network, there appears the need to establish QKD keys between multiple nodes. Making point-to-point connections between every pair of nodes becomes infeasible when the number of nodes increases. Accordingly, additional techniques may be needed to reduce the number of devices required. Multiple connections can be achieved, for example, by using optical splitters.

Further, a QKD network constructed with point-to-point links requires a large number of QKD devices. Conventionally, for every pair of nodes that need to establish a QKD key, a direct point-to-point link is needed.

For example, when there are two sets of nodes each with N nodes and if there is a requirement that every node in one set can create a QKD key with every node in the other set, a point-to-point construction may require N*(N−1)/2 links to be created which means that N*(1−N) number of devices are needed.

Further, the quantum state sent by a QKD transmitter entity (or sender) is usually implemented as an optical signal (e.g. an optical pulse) and sent over an optical fiber connecting the transmitter and the receiver or over free space. In conventional QKD implementations, there are synchronization channels that are used to synchronize a transmitter and the corresponding receiver entity in terms of physical dimensions such as timing and the optical phase. In CV-QKD, such a synchronization channel may take the form of an optical pilot tone signal that may be transmitted together with the quantum optical signal in a dense wavelength-division multiplexing (DWDM) channel.

For example, the quantum optical signal may occupy the lower frequency band and the optical pilot tone signal may occupy the upper frequency band of the DWDM channel. These signals may be extracted in a subsequent electrical operation at the receiver easily.

On the other hand, in typical DV-QKD systems, a synchronization channel may take the form of a signal transmitted over a separate fiber from the fiber used to transmit the quantum optical signal, or may take the form of a signal transmitted over a separate DWDM channel from the DWDM channel used to transmit the quantum optical signal.

### SUMMARY

In view of the above, this disclosure aims to improve the conventional CV-QKD systems and methods. An objective is to provide a system and a method that enable optical connections between multiple transmitters and multiple receivers of the CV-QKD system by using one or more optical splitters, with reduced costs for building a network and that simplifies the network architecture. Another objective is to enable the CV-QKD system to generate both pairwise secret keys and multi-party common secret keys between different transmitters and different receivers of the CV-QKD system.

These and other objectives are achieved by the solutions provided in the independent claims. Advantageous implementations are further defined in the dependent claims.

A first aspect of the disclosure provides a CV-QKD system comprising a plurality of transmitters, one or more splitters, and a plurality of receivers. Each transmitter is configured to modulate a quantum signal according to a discrete or continuous distribution in phase and amplitude. Each splitter is configured to distribute N modulated quantum signals into M modulated quantum sub-signals, wherein N≥1 and M≥2 or wherein N≥2 and M≥1, and wherein at least some of the N modulated quantum signals are received by each splitter from a respective transmitter or from another splitter. Each receiver is configured to: receive, via a respective quantum channel, a modulated quantum sub-signal associated to one or more of the plurality of transmitters from the one or more splitters; detect one or more quadrature components of the received modulated quantum sub-signal; and perform a respective post-processing protocol with one or more of the plurality of transmitters to generate one or more individual final secret keys between the one or more transmitters and the receiver and/or one or more common secret keys between the one or more transmitters and the plurality of receivers based on the detected one or more quadrature components.

Each optical splitter may take multiple inputs and splits or merge them to multiple outputs. Thereby, instead of having a direct optical connection between one Alice and one Bob, the one or more splitters can be used to connect multiple Alices and multiple Bobs such that the signals from one Alice can reach multiple Bobs. This creates multiple optical paths between one or more Alices and one or more Bobs and, thus, enables QKD among multiple parties (i.e., transmitters and receivers).

Further, the modulated quantum signals transmitted by each of the transmitters do not need to be directly coupled to one splitter, but they may travel over one or more of the splitters, enabling the quantum signals from multiple Alices to reach multiple distant Bobs. This allows dynamic grouping of QKD parties or components without active physical layer control. Thereby, with the use of the one or more splitters, the number of nodes required in a QKD network may be reduced, further decreasing the cost for building the network and simplifying the network architecture. This can be implemented in optical fiber links and free-space links.

The multiple optical paths between multiple Alices and multiple Bobs enable the transmitters and receivers of the CV-QKD system to implement different post-processing protocols to generate pairwise secret keys (i.e., keys between two parties of the CV-QKD system) and/or multi-party secret keys. Remarkably, said multi-party secret keys may comprise keys among three or more components (transmitter and receivers) of the CV-QKD system.

In an implementation form of the first aspect, each splitter is a passive optical splitter.

In an implementation form of the first aspect, each splitter comprises a plurality of N×M ports wherein N≥1 and M≥2 or wherein N≥2 and M≥1, and each of the N×M ports are configured to act simultaneously as an input port and as an output port. This allows dynamic interconnection of multiple transmitters and multiple receivers with different communication directions.

In an implementation form of the first aspect, each splitter is further configured to receive the N modulated quantum signals transmitted by a respective transmitter. Additionally or alternatively, each splitter is further configured to provide one or more of the M modulated quantum sub-signals to a respective receiver or to another splitter.

In an implementation form of the first aspect, one or more of the N×M ports of each splitter is further coupled to a circulating unit. The circulating unit is configured to provide a modulated quantum sub-signal received from the one or more ports to one of the plurality of receivers or to another splitter. Additionally or alternatively, the circulating unit may provide a modulated quantum signal or a modulated quantum sub-signal transmitted to the one or more ports from one of the plurality of transmitters or from another splitter, respectively. This further allows the dynamic interconnection of multiple transmitters and multiple receivers with different communication directions.

In an implementation form of the first aspect, CV-QKD system further comprises one or more optical switches. Each optical switch is configured to: receive one or more modulated quantum signals from a respective transmitter and/or one or more modulated quantum sub-signals from one or more of the splitters; and direct each received modulated quantum signals and/or each received modulated quantum sub-signal to one of the plurality of receivers or to another splitter.

Accordingly, dynamic interconnections of multiple transmitters and multiple receivers are allowed with flexibility in constructing sophisticated networks with different optical devices, such as splitters and switches.

In an implementation form of the first aspect, each transmitter is further configured to transmit a synchronization signal to one or more of the plurality of receivers through the one or more splitters.

In an implementation form of the first aspect, each transmitter is further configured to transmit the synchronization signal together with the modulated quantum signal. Thus, synchronization classical signals, or other classical signals, may be transmitted inband with the QKD signal, thereby eliminating the need to transmit classical signals on different spatial channels.

In an implementation form of the first aspect, at least two receivers receive a respective modulated quantum sub-signal associated to at least one of the transmitters from the one or more splitters, and the respective post-processing protocol to generate one or more individual final secret keys comprises: the transmitter and a first receiver generate a first individual final secret key between them by performing a first QKD post-processing, wherein a part of the modulated quantum signal from the transmitter distributed by the one or more splitters into the respective modulated quantum sub-signal that is received by a second receiver is considered to be lost to an eavesdropper; and the transmitter and the second receiver generate a second individual final secret key between them by performing a second QKD post-processing, wherein a part of the modulated quantum signal from the transmitter distributed by the one or more splitters into the respective modulated quantum sub-signal that is received by the first receiver is considered to be lost to the eavesdropper. Thus, dynamic interconnections of multiple transmitters and multiple receivers are allowed with the possibility to efficiently establish individual keys between different pairs of transmitters and receivers.

In an implementation form of the first aspect, at least two receivers receive a respective modulated quantum sub-signal associated to at least one of the transmitters from the one or more splitters, and the respective post-processing protocol to generate one or more individual final secret keys comprises: each of a first receiver and a second receiver sends to the transmitter one or more respective data samples taken from the respective received modulated quantum sub-signal; the transmitter collectively estimates a first quantum channel of the first receiver and a second quantum channel of the second receiver; the transmitter and the first receiver generate a first individual final secret key between them by performing a third QKD post-processing on the estimated first quantum channel, and the first transmitter and the second receiver generate a second individual final secret key between them by performing a fourth QKD post-processing on the estimated second quantum channel. Thus, dynamic interconnections of multiple transmitters and multiple receivers are allowed with the possibility to efficiently establish individual keys between different pairs of transmitters and receivers.

In an implementation form of the first aspect, the respective post-processing protocol to generate one or more common final secret keys comprises: after each of the at least one transmitter collectively estimates the first quantum channel of the first receiver and the second quantum channel of the second receiver, the transmitter and each of the at least two receivers perform forward information reconciliation and establish a common key between the transmitter and the at least two receivers; and the transmitter and the at least two receivers distill a final common secret key by using a post-selection method. Accordingly, dynamic interconnections of multiple transmitters and multiple receiver are allowed with the possibility to efficiently establish common keys between different transmitters and different receivers, where a common key is shared between at least three parties.

In an implementation form of the first aspect, each of at least two receivers receives a respective modulated quantum sub-signal associated to at least two transmitters from the one or more splitters, and the respective post-processing protocol to generate one or more individual final secret keys comprises: each transmitter and a first receiver generate a respective individual final secret key between the transmitter and the first receiver by performing a respective QKD post-processing, wherein a part of the modulated quantum signal transmitted from each transmitter and distributed by the one or more splitters that is received by the second receiver in the respective modulated quantum sub-signal is considered to be lost to an eavesdropper; and each transmitter and a second receiver generate a respective individual final secret key between the transmitter and the second receiver by performing a respective QKD post-processing, wherein a part of the modulated quantum signal transmitted from each transmitter and distributed by the one or more splitters that is received by the first receiver in the respective modulated quantum sub-signal is considered to be lost to an eavesdropper. Thus, dynamic interconnections of multiple transmitters and multiple receivers are allowed with the possibility to efficiently establish individual keys between different pairs of transmitters and receivers.

In an implementation form of the first aspect, each of at least two receivers receives a respective modulated quantum sub-signal associated to at least two transmitters from the one or more splitters, and the respective post-processing protocol to generate one or more individual final secret keys comprises: each receiver sends to each transmitter, via a respective secure classical channel, one or more respective data samples from the respective modulated quantum sub-signal; each transmitter collectively estimates a first quantum channel of the first receiver and a second quantum channel of the second receiver; each transmitter and the first receiver generate a respective individual final secret key between the transmitter and the first receiver by performing a respective QKD post-processing on the respective estimated first quantum channel; and each transmitter and the second receiver generate a respective individual final secret key between the transmitter and the second receiver by performing a respective QKD post-processing on the respective estimated second quantum channel, wherein the at least two transmitters transmit the respective modulated quantum signal through the one or more splitters using time multiplexing. Accordingly, dynamic interconnections of multiple transmitters and multiple receivers are allowed with the possibility to efficiently establish individual keys between pairs of transmitters and receivers.

In an implementation form of the first aspect, at least one receiver receives a respective modulated quantum sub-signal associated to at least two transmitters from the one or more splitters, the at least two transmitters transmitting the respective modulated quantum signal through the one or more splitters using time multiplexing, and the respective post-processing protocol to generate one or more individual final secret keys comprises: the receiver receives the respective modulated quantum sub-signal associated to each of the at least two transmitters from the one or more splitters at a different time; and each transmitter and the receiver perform a respective QKD post-processing to generate a respective individual final secret final key between each transmitter and the receiver. Accordingly, dynamic interconnections of multiple transmitters and multiple receivers are allowed with the possibility to efficiently establish individual keys between different pairs of transmitters and receivers.

In an implementation form of the first aspect, at least one receiver receives a respective modulated quantum sub-signal associated to at least two transmitters from the one or more splitters, the at least two transmitters transmitting the respective modulated quantum signal through the one or more splitters using frequency multiplexing, and the respective post-processing protocol to generate one or more individual final secret keys comprises: the receiver receives the respective quantum sub-signal associated to each of the at least two transmitters at a different frequency; and each transmitter and the receiver perform a respective QKD post-processing to generate a respective individual final secret key between each transmitter and the receiver. Thus, dynamic interconnections of multiple transmitters and multiple receivers are allowed with the possibility to efficiently establish individual keys between different pairs of transmitters and receivers.

In an implementation form of the first aspect, at least one receiver receives a respective modulated quantum sub-signal associated to at least two transmitters from the one or more splitters, and the respective post-processing protocol to generate one or more individual final secret keys comprises: the receiver receives from the one or more splitters a combined signal, the combined signal comprising the respective modulated quantum sub-signals associated to the at least two transmitters received by the receiver at a same time and/or at a same frequency and/or at a same polarization; the receiver announces the combined signal to the at least two transmitters via a respective classical secure channel; and the at least two transmitters perform a respective QKD post-processing to generate an individual final secret key between them.

Thus, dynamic interconnections of multiple transmitters and multiple receivers are allowed with the possibility to efficiently establish individual keys between different pairs of transmitters and receivers.

In an implementation form of the first aspect, at least one receiver receive a respective modulated quantum sub-signal associated to at least two transmitters from the one or more splitters, and the respective post-processing protocol to generate one or more individual final secret keys comprises: a first transmitter announces its respective modulated quantum signal to a second transmitter and to the receiver via a respective classical secure channel; the receiver determines a signal comprising a noisy version of the modulated quantum sub-signal associated to the second transmitter received from the one or more splitters; and the second transmitter and the receiver perform a respective QKD post-processing to generate an individual final secret key between them. Thus, dynamic interconnections of multiple transmitters and multiple receivers are allowed with the possibility to efficiently establish individual keys between different pairs of transmitters and receivers.

In an implementation form of the first aspect, at least two receivers receive a respective modulated quantum sub-signal associated to at least one of the transmitters from the one or more splitters, and the respective post-processing protocol to generate one or more common final secret keys comprises: the transmitter generates a random string having a length equal to a length of the first individual final secret key between the transmitter and the first receiver; the transmitter generates a first encrypted string by encrypting the random string using the first individual final secret key, and generates a second encrypted string by encrypting the random string using the second individual final secret key; the transmitter sends the first encrypted string to the first receiver and the second encrypted string to the second receiver; and each of the first receiver and the second receiver obtains a respective final common secret key between the transmitter and the at least two receivers by decrypting the respective received first encrypted string and the second encrypted string, the final common secret key comprising the random string generated by the transmitter. Thus, dynamic interconnections of multiple transmitters and multiple receiver are allowed with the possibility to efficiently establish common keys between multiple transmitters and multiple receivers, where a common key is shared between at least three parties.

In an implementation form of the first aspect, at least two receivers receive a respective modulated quantum sub-signal associated to at least one of the transmitters from the one or more splitters, and the respective post-processing protocol to generate one or more common final secret keys further comprises: the transmitter generates an encrypted string by encrypting the first individual final secret key using the second individual final secret key; the transmitter sends the encrypted string to the second receiver; and the second receiver obtains a final common key between the transmitter and the at least two receivers by decrypting the received encrypted string using the second individual final secret key and extracting the first individual final secret key from the decrypted encrypted string, the final common key between the transmitter and the at least two receivers comprising the first individual final secret key. Thus, dynamic interconnections of multiple transmitters and multiple receiver are allowed with the possibility to efficiently establish common keys between multiple transmitters and multiple receivers, where a common key is shared between at least three parties.

In an implementation form of the first aspect, the plurality of transmitters, the plurality of receivers and the one or more splitters are arranged forming a plurality of transmitting nodes and a plurality of receiving nodes, each transmitting node comprising one transmitter connected to a first splitter, and each receiving node comprising one receiver connected to a second splitter. The plurality of transmitting nodes and the plurality of receiving nodes are arranged in an alternating manner, so that each transmitting node has a neighbour receiving node, and each transmitting node and each neighbour receiving node share the respective transmitter and the respective receiver. The first splitter of each transmitting node receives a modulated quantum signal from the respective transmitter, and the second splitter of each receiving node receives a modulated quantum sub-signal from the respective first splitter of two of the transmitting nodes. The receiver of each receiving node receives a modulated quantum sub-signal associated to two respective transmitters of two neighbouring transmitting nodes from the respective second splitter. This allows a minimal deployment of equipment over a chain of nodes.

In an implementation form of the first aspect, the receiver of each receiving node is configured to perform a respective post-processing protocol with the transmitter of a respective neighbour transmitting node to generate a respective individual final secret key between the receiver and a respective the transmitter of each neighbour transmitting node.

In an implementation form of the first aspect, the respective post-processing protocol to generate one or more individual final secret keys further comprises generating an individual final secret key between a pair of distant nodes, each node comprising one of the plurality of transmitting nodes or one of the plurality of the receiving nodes. This provides that dynamic interconnections of multiple transmitters and multiple receivers are allowed with the possibility to efficiently establish individual keys between distant pairs of transmitters and receivers.

In an implementation form of the first aspect, generating the individual final secret key between the pair of distant nodes comprises: generating, by a first transmitter or a first receiver of a first node, a random key string to be shared between the first transmitter or the first receiver and a second transmitter or a second receiver of a second node, wherein the first node and the second node are separated by one or more neighbour nodes, each neighbour node comprising a receiving node or a transmitting node; encrypting, by the first transmitter or the first receiver, the random key using the individual final secret key between the first transmitter or the first receiver and the respective receiver or transmitter of a respective one neighbour node, and sending the encrypted random key to the respective neighbour node; obtaining, by the receiver or the transmitter of each neighbour node, the random key string by decrypting the received encrypted random key using the individual final secret key between the transmitter or the receiver of each neighbour node and the respective receiver or transmitter of a previous neighbour node; encrypting, by receiver or the transmitter of each neighbour node, the random key using the individual final secret key between the transmitter or the receiver of the neighbour node and the respective receiver or transmitter of a respective next neighbour node, and sending the encrypted random key to the respective next neighbour node; and obtaining, by the second transmitter or the second receiver of the second node, the random key string by decrypting the encrypted random key received from the respective previous neighbour node using the individual final secret key between the second transmitter or the second receiver and the respective receiver or transmitter of the respective previous neighbour node.

In an implementation form of the first aspect, each QKD post-processing comprises one or more of: a parameter estimation stage, a sifting stage, a symbol mapping stage, an information reconciliation stage, and a privacy amplification stage.

In an implementation form of the first aspect, the CV-QKD system further comprises a controller, the controller being configured to control the operation of the plurality of transmitters, the plurality of receivers and the one or more splitters. This provides facilitating the establishment of reconciliation channels between the transmitters and receivers.

A second aspect of the disclosure provides an optical network comprising the CV-QKD system according to the first aspect. The optical network according to the second aspect and its implementation forms provide the same advantages and effects as described above for the system of the first aspect and its respective implementation forms.

A third aspect of the disclosure provides a method for a CV-QKD system. The method comprises: modulating, with each transmitter of a plurality of transmitters, a quantum signal according to a discrete or continuous distribution in phase and amplitude; distributing, with each splitter of one or more splitters, N modulated quantum signals into M modulated quantum sub-signals, wherein N≥1 and M≥2 or wherein N≥2 and M≥1, and wherein at least some of the N modulated quantum signals are received by each splitter from a respective transmitter or from another splitter; receiving, with each receiver of a plurality of receivers via a respective quantum channel, a modulated quantum sub-signal associated to one or more of the plurality of transmitters from the one or more splitters; detecting, with the receiver, one or more quadrature components of the received modulated quantum sub-signal; and performing, with the receiver, a respective post-processing protocol with one or more of the plurality of transmitters to generate one or more individual final secret keys between the one or more transmitters and the receiver and/or one or more common secret keys between the one or more transmitters and the plurality of receivers based on the detected one or more quadrature components.

In an implementation form of the third aspect, each splitter is a passive optical splitter.

In an implementation form of the third aspect, each splitter comprises a plurality of N×M ports wherein N≥1 and M≥2 or wherein N≥2 and M≥1, and each of the N×M ports are configured to act simultaneously as an input port and as an output port. This allows dynamic interconnection of multiple transmitters and multiple receivers with different communication directions.

In an implementation form of the third aspect, the method further comprises receiving, with each splitter, the N modulated quantum signals transmitted by a respective transmitter. Additionally or alternatively, providing, with each splitter, one or more of the M modulated quantum sub-signals to a respective receiver or to another splitter.

In an implementation form of the third aspect, the method further comprises providing, with a circulating unit coupled to one or more of the N×M ports of each splitter, a modulated quantum sub-signal received from the one or more ports to one of the plurality of receivers or to another splitter.

Additionally or alternatively, the circulating unit may provide a modulated quantum signal or a modulated quantum sub-signal transmitted to the one or more ports from one of the plurality of transmitters or from another splitter, respectively. This further allows the dynamic interconnection of multiple transmitters and multiple receivers with different communication directions.

In an implementation form of the third aspect, the method further comprises: receiving, with each of one or more optical switches, one or more modulated quantum signals from a respective transmitter and/or one or more modulated quantum sub-signals from one or more of the splitters; and directing, with each optical switch, each received modulated quantum signals and/or each received modulated quantum sub-signal to one of the plurality of receivers or to another splitter. Thus, dynamic interconnections of multiple transmitters and multiple receivers are allowed with flexibility in constructing sophisticated networks with different optical devices, such as splitters and switches.

In an implementation form of the third aspect, the method further comprises transmitting, with each transmitter, a synchronization signal to one or more of the plurality of receivers through the one or more splitters.

In an implementation form of the third aspect, the method further comprises transmitting, with each transmitter, the synchronization signal together with the modulated quantum signal. Thus, synchronization classical signals, or other classical signals, may be transmitted inband with the QKD signal, thereby eliminating the need to transmit classical signals on different spatial channels.

In an implementation form of the third aspect, the method comprises receiving, with at least two receivers, a respective modulated quantum sub-signal associated to at least one of the transmitters from the one or more splitters; and the respective post-processing protocol to generate one or more individual final secret keys comprises: generating, with the transmitter and a first receiver, a first individual final secret key between them by performing a first QKD post-processing, wherein a part of the modulated quantum signal from the transmitter distributed by the one or more splitters into the respective modulated quantum sub-signal that is received by a second receiver is considered to be lost to an eavesdropper; and generating, with the transmitter and the second receiver, a second individual final secret key between them by performing a second QKD post-processing, wherein a part of the modulated quantum signal from the transmitter distributed by the one or more splitters into the respective modulated quantum sub-signal that is received by the first receiver is considered to be lost to the eavesdropper. Thus, dynamic interconnections of multiple transmitters and multiple receivers are allowed with the possibility to efficiently establish individual keys between different pairs of transmitters and receivers.

In an implementation form of the third aspect, the method comprises receiving, with at least two receivers, a respective modulated quantum sub-signal associated to at least one of the transmitters from the one or more splitters; and the respective post-processing protocol to generate one or more individual final secret keys comprises: sending to the transmitter, with each of a first receiver and a second receiver, one or more respective data samples taken from the respective received modulated quantum sub-signal; collectively estimating, with the transmitter, a first quantum channel of the first receiver and a second quantum channel of the second receiver; generating, with the transmitter and the first receiver, a first individual final secret key between them by performing a third QKD post-processing on the estimated first quantum channel; and generating, with the first transmitter and the second receiver, a second individual final secret key between them by performing a fourth QKD post-processing on the estimated second quantum channel. Thus, dynamic interconnections of multiple transmitters and multiple receivers are allowed with the possibility to efficiently establish individual keys between different pairs of transmitters and receivers.

In an implementation form of the third aspect, the respective post-processing protocol to generate one or more common final secret keys comprises: performing, the transmitter and each of the at least two receivers forward information reconciliation after collectively estimating the first quantum channel of the first receiver and the second quantum channel of the second receiver with each of the at least one transmitter, and establishing a common key between the transmitter and the at least two receivers; and distilling, with the transmitter and the at least two receivers, a final common secret key by using a post-selection method. Thus, dynamic interconnections of multiple transmitters and multiple receiver are allowed with the possibility to efficiently establish common keys between different transmitters and different receivers, where a common key is shared between at least three parties.

In an implementation form of the third aspect, the method comprises receiving, with each of at least two receivers, a respective modulated quantum sub-signal associated to at least two transmitters from the one or more splitters, and the respective post-processing protocol to generate one or more individual final secret keys comprises: generating, with each transmitter and a first receiver, a respective individual final secret key between the transmitter and the first receiver by performing a respective QKD post-processing, wherein a part of the modulated quantum signal transmitted from each transmitter and distributed by the one or more splitters that is received by the second receiver in the respective modulated quantum sub-signal is considered to be lost to an eavesdropper; and generating, with each transmitter and a second receiver, a respective individual final secret key between the transmitter and the second receiver by performing a respective QKD post-processing, wherein a part of the modulated quantum signal transmitted from each transmitter and distributed by the one or more splitters that is received by the first receiver in the respective modulated quantum sub-signal is considered to be lost to an eavesdropper. Thus, dynamic interconnections of multiple transmitters and multiple receivers are allowed with the possibility to efficiently establish individual keys between different pairs of transmitters and receivers.

In an implementation form of the third aspect, the method comprises receiving, with each of at least two receivers, a respective modulated quantum sub-signal associated to at least two transmitters from the one or more splitters, and the respective post-processing protocol to generate one or more individual final secret keys comprises: sending to each transmitter, with each receiver, via a respective secure classical channel, one or more respective data samples from the respective modulated quantum sub-signal; collectively estimating, with each transmitter, a first quantum channel of the first receiver and a second quantum channel of the second receiver; generating, with each transmitter and the first receiver, a respective individual final secret key between the transmitter and the first receiver by performing a respective QKD post-processing on the respective estimated first quantum channel; and generating, with each transmitter and the second receiver, a respective individual final secret key between the transmitter and the second receiver by performing a respective QKD post-processing on the respective estimated second quantum channel, wherein the at least two transmitters transmit the respective modulated quantum signal through the one or more splitters using time multiplexing. Thus, dynamic interconnections of multiple transmitters and multiple receivers are allowed with the possibility to efficiently establish individual keys between pairs of transmitters and receivers.

In an implementation form of the third aspect, the method comprises receiving, with at least one receiver, a respective modulated quantum sub-signal associated to at least two transmitters from the one or more splitters, the at least two transmitters transmitting the respective modulated quantum signal through the one or more splitters using time multiplexing; and the respective post-processing protocol to generate one or more individual final secret keys comprises: receiving, with the receiver, the respective modulated quantum sub-signal associated to each of the at least two transmitters from the one or more splitters at a different time; and performing, with each transmitter and the receiver, a respective QKD post-processing to generate a respective individual final secret final key between each transmitter and the receiver. Thus, dynamic interconnections of multiple transmitters and multiple receivers are allowed with the possibility to efficiently establish individual keys between different pairs of transmitters and receivers.

In an implementation form of the third aspect, the method comprises receiving, with at least one receiver, a respective modulated quantum sub-signal associated to at least two transmitters from the one or more splitters, the at least two transmitters transmitting the respective modulated quantum signal through the one or more splitters using frequency multiplexing; and the respective post-processing protocol to generate one or more individual final secret keys comprises: receiving, with the receiver, the respective quantum sub-signal associated to each of the at least two transmitters at a different frequency; and performing, with each transmitter and the receiver, a respective QKD post-processing to generate a respective individual final secret key between each transmitter and the receiver. Thus, dynamic interconnections of multiple transmitters and multiple receivers are allowed with the possibility to efficiently establish individual keys between different pairs of transmitters and receivers.

In an implementation form of the third aspect, the method comprises receiving, with at least one receiver, a respective modulated quantum sub-signal associated to at least two transmitters from the one or more splitters; and the respective post-processing protocol to generate one or more individual final secret keys comprises: receiving, with the receiver, from the one or more splitters a combined signal, the combined signal comprising the respective modulated quantum sub-signals associated to the at least two transmitters received by the receiver at a same time and/or at a same frequency and/or at a same polarization; announcing, with the receiver, the combined signal to the at least two transmitters via a respective classical secure channel; and performing, with the at least two transmitters, a respective QKD post-processing to generate an individual final secret key between them. Thus, dynamic interconnections of multiple transmitters and multiple receivers are allowed with the possibility to efficiently establish individual keys between different pairs of transmitters and receivers.

In an implementation form of the third aspect, the method comprises receiving, with at least one receiver, a respective modulated quantum sub-signal associated to at least two transmitters from the one or more splitters; and the respective post-processing protocol to generate one or more individual final secret keys comprises: announcing, with a first transmitter, its respective modulated quantum signal to a second transmitter and to the receiver via a respective classical secure channel; determining, with the receiver, a signal comprising a noisy version of the modulated quantum sub-signal associated to the second transmitter received from the one or more splitters; and performing, with the second transmitter and the receiver, a respective QKD post-processing to generate an individual final secret key between them. Thus, dynamic interconnections of multiple transmitters and multiple receivers are allowed with the possibility to efficiently establish individual keys between different pairs of transmitters and receivers.

In an implementation form of the third aspect, the method comprises receiving, with at least two receivers, a respective modulated quantum sub-signal associated to at least one of the transmitters from the one or more splitters; and the respective post-processing protocol to generate one or more common final secret keys comprises: generating, with the transmitter, a random string having a length equal to a length of the first individual final secret key between the transmitter and the first receiver; generating, with the transmitter, a first encrypted string by encrypting the random string using the first individual final secret key, and a second encrypted string by encrypting the random string using the second individual final secret key; sending, with the transmitter, the first encrypted string to the first receiver and the second encrypted string to the second receiver; and obtaining, with each of the first receiver and the second receiver, a respective final common secret key between the transmitter and the at least two receivers by decrypting the respective received first encrypted string and the second encrypted string, the final common secret key comprising the random string generated by the transmitter.

Thus, dynamic interconnections of multiple transmitters and multiple receiver are allowed with the possibility to efficiently establish common keys between multiple transmitters and multiple receivers, where a common key is shared between at least three parties.

In an implementation form of the third aspect, the method comprises receiving, with at least two receivers, a respective modulated quantum sub-signal associated to at least one of the transmitters from the one or more splitters; and the respective post-processing protocol to generate one or more common final secret keys further comprises: generating, with the transmitter, an encrypted string by encrypting the first individual final secret key using the second individual final secret key; sending, with the transmitter, the encrypted string to the second receiver; and obtaining, with the second receiver, a final common key between the transmitter and the at least two receivers by decrypting the received encrypted string using the second individual final secret key and extracting the first individual final secret key from the decrypted encrypted string, the final common key between the transmitter and the at least two receivers comprising the first individual final secret key. Thus, dynamic interconnections of multiple transmitters and multiple receiver are allowed with the possibility to efficiently establish common keys between multiple transmitters and multiple receivers, where a common key is shared between at least three parties.

In an implementation form of the third aspect, the method comprises arranging the plurality of transmitters, the plurality of receivers and the one or more splitters forming a plurality of transmitting nodes and a plurality of receiving nodes, each transmitting node comprising one transmitter connected to a first splitter, and each receiving node comprising one receiver connected to a second splitter; arranging the plurality of transmitting nodes and the plurality of receiving nodes in an alternating manner, so that each transmitting node has a neighbour receiving node, wherein each transmitting node and each neighbour receiving node share the respective transmitter and the respective receiver; receiving, with the first splitter of each transmitting node, a modulated quantum signal from the respective transmitter, and receiving, with the second splitter of each receiving node, a modulated quantum sub-signal from the respective first splitter of two of the transmitting nodes; and receiving, with the receiver of each receiving node, a modulated quantum sub-signal associated to two respective transmitters of two neighbouring transmitting nodes from the respective second splitter. This allows a minimal deployment of equipment over a chain of nodes.

In an implementation form of the third aspect, the method further comprises performing, with the receiver of each receiving node, a respective post-processing protocol with the transmitter of a respective neighbour transmitting node to generate a respective individual final secret key between the receiver and a respective the transmitter of each neighbour transmitting node.

In an implementation form of the third aspect, the respective post-processing protocol to generate one or more individual final secret keys further comprises generating an individual final secret key between a pair of distant nodes, each node comprising one of the plurality of transmitting nodes or one of the plurality of the receiving nodes. Thus, dynamic interconnections of multiple transmitters and multiple receivers are allowed with the possibility to efficiently establish individual keys between distant pairs of transmitters and receivers.

In an implementation form of the third aspect, generating the individual final secret key between the pair of distant nodes comprises: generating, by a first transmitter or a first receiver of a first node, a random key string to be shared between the first transmitter or the first receiver and a second transmitter or a second receiver of a second node, wherein the first node and the second node are separated by one or more neighbour nodes, each neighbour node comprising a receiving node or a transmitting node; encrypting, by the first transmitter or the first receiver, the random key using the individual final secret key between the first transmitter or the first receiver and the respective receiver or transmitter of a respective one neighbour node, and sending the encrypted random key to the respective neighbour node; obtaining, by the receiver or the transmitter of each neighbour node, the random key string by decrypting the received encrypted random key using the individual final secret key between the transmitter or the receiver of each neighbour node and the respective receiver or transmitter of a previous neighbour node; encrypting, by receiver or the transmitter of each neighbour node, the random key using the individual final secret key between the transmitter or the receiver of the neighbour node and the respective receiver or transmitter of a respective next neighbour node, and sending the encrypted random key to the respective next neighbour node; and obtaining, by the second transmitter or the second receiver of the second node, the random key string by decrypting the encrypted random key received from the respective previous neighbour node using the individual final secret key between the second transmitter or the second receiver and the respective receiver or transmitter of the respective previous neighbour node.

In an implementation form of the third aspect, each QKD post-processing comprises one or more of: a parameter estimation stage, a sifting stage, a symbol mapping stage, an information reconciliation stage, and a privacy amplification stage.

In an implementation form of the third aspect, the method further comprises controlling, with a controller, the operation of the plurality of transmitters, the plurality of receivers and the one or more splitters. This facilitates the establishment of reconciliation channels between the transmitters and receivers.

The method according to the third aspect its implementation forms provide the same advantages and effects as described above for the system of the first aspect and its respective implementation forms.

A fourth aspect of the disclosure provides a computer program comprising instructions which, when the program is executed by a computer, cause the computer to carry out the method according to the second aspect. The computer program product according to the fourth aspect and their implementation forms provide the same advantages and effects as described above for the method according to the third aspect and its respective implementation forms.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF THE DRAWINGS

The above described aspects and implementation forms of the present disclosure will be explained in the following description of more specific embodiments in relation to the enclosed drawings, in which:

FIG. 1 is a schematic view of a CV-QKD system according to this disclosure;

FIG. 2 is a schematic view of a CV-QKD system according to this disclosure;

FIG. 3 is a schematic view of a CV-QKD system according to this disclosure;

FIG. 4 is a schematic view of a CV-QKD system according to this disclosure;

FIG. 5 is a schematic view of a CV-QKD system according to this disclosure;

FIG. 6 is a schematic view of a CV-QKD system according to this disclosure;

FIG. 7 is a schematic view of a CV-QKD system according to this disclosure;

FIG. 8 is a schematic view of a CV-QKD system according to this disclosure;

FIG. 9 is a schematic view of a CV-QKD system according to this disclosure;

FIG. 10 is a schematic view of an exemplary optical network 1000 comprising a CV-QKD system 100 according to this disclosure; and

FIG. 11 is a flowchart of a method for a CV-QKD system according to this disclosure.

### DETAILED DESCRIPTION OF ILLUSTRATIVE EMBODIMENTS

In a conventional QKD protocol, a transmitter (corresponding to the user Alice) prepares a quantum state selected from a pre-agreed set. The quantum state is then transmitted to a receiver (corresponding to the user Bob), in the presence of an eavesdropper (corresponding to Eve), over a quantum channel. Hereinafter, the terms “transmitter” and “Alice” will be used interchangeably. Likewise, the terms “receiver” and “Bob” will be used interchangeably.

The receiver detects the received signal with a detection system which implements a quantum measurement. In DV-QKD, it is often the case that detection in the receiver is tuned to a random setting for each received signal and this setting corresponds to a quantum basis of the measurement. Since the setting is randomly chosen, a result of the measurement may be completely uncorrelated with the state that the transmitter has sent (when the setting is chosen to be incompatible with Alice's state). These uncorrelated cases are dropped in a sifting step later.

After transmission of the quantum state, the transmitter and the receiver may perform QKD post-processing on classical computing devices connected by a classical error-free, authenticated, and unjammable channel (also called the post-processing channel) in order to transform the raw data into a final secret key. The QKD post-processing generally comprises a few main steps: parameter estimation, sifting (or basis selection), symbol mapping, information reconciliation, and privacy amplification.

The quantum state sent by the transmitter is usually implemented as an optical signal (e.g. an optical pulse) and sent over an optical fiber connecting the transmitter and the receiver or over free space.

In conventional QKD implementations, there are synchronization channels that are used to synchronize a transmitter and the corresponding receiver in terms of physical dimensions, such as timing and the optical phase. In CV-QKD, such a synchronization channel may take the form of an optical pilot tone signal that may be transmitted together with the quantum optical signal in dense wavelength-division multiplexing (DWDM) channel. For example, the quantum optical signal may occupy the lower frequency band and the optical pilot tone signal may occupy the upper frequency band of the DWDM channel. These signals may be extracted in a subsequent electrical operation at the receiver easily.

On the other hand, in typical DV-QKD systems, a synchronization channel may take the form of a signal transmitted over a separate fiber from the fiber used to transmit the quantum optical signal, or may take the form of a signal transmitted over a separate DWDM channel from the DWDM channel used to transmit the quantum optical signal.

This disclosure concerns the provision of optical paths (in an optical fiber and/or in the free-space) to connect multiple transmitters and multiple receivers in a QKD system.

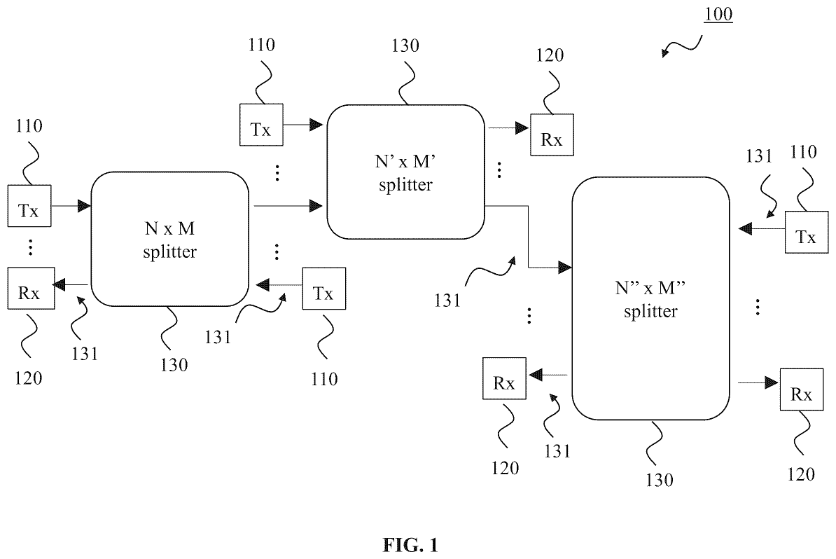

FIG. 1 is a schematic view of an exemplary embodiment of a CV-QKD system 100 according to this disclosure.

The system 100 may comprise processing circuitry (not shown) configured to perform, conduct or initiate the various operations of the system 100 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes the system 100 to perform, conduct or initiate the operations or methods described herein.

The CV QKD system 100 comprises a plurality of transmitters 110, a plurality of receivers 120 and one or more splitters 130.

Each transmitter 110 of the plurality of transmitters 110 may comprise processing circuitry (not shown) configured to perform, conduct or initiate the various operations of each transmitter 110 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes each transmitter 110 to perform, conduct or initiate the operations or methods described herein.

Further, each receiver 120 of the plurality of receivers 120 may comprise processing circuitry (not shown) configured to perform, conduct or initiate the various operations of each receiver 110 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes each receiver 120 to perform, conduct or initiate the operations or methods described herein.

Each transmitter 110 is configured to modulate a respective quantum signal according to a discrete or continuous distribution in phase and amplitude.

For example, each transmitter 110 may comprise a respective modulator (not shown) and each modulator may be configured to modulate the respective quantum signal according to the discrete or continuous distribution in phase and amplitude.

Further, each transmitter may be configured to transmit the respective modulated quantum signal to one or more of the splitters 130. Thereby, each transmitter 100 may be optically coupled to the one or more splitters 130.

Each splitter 130 of the one or more splitters 130 a passive optical splitter 130.

Each splitter 130 is configured to receive N modulated quantum signals, and to further distribute the N modulated quantum signals into M modulated quantum sub-signals, where N≥1 and M≥2 or, alternatively, where N≥2 and M≥1, i.e. max(N, M)≥2.

Distributing, by each splitter 130, the N modulated quantum signals into M modulated quantum sub-signals may comprise splitting one or more of the N modulated quantum signals into a plurality of modulated quantum sub-signals. Each of the modulated quantum sub-signal may comprise an attenuated version of the respective modulated quantum signal.

Alternatively, distributing, by each splitter 130, the N modulated quantum signals into M modulated quantum sub-signals may comprise merging two or more of the received N modulated quantum signals into a plurality of modulated quantum sub-signals. In this case, each of the modulated quantum sub-signals may comprise an attenuated version of each of the respective two or more modulated quantum signals.

At least some of the N modulated quantum signals are received by each splitter 130 from a respective transmitter 110 or from another splitter 130. Alternatively, each splitter 130 is further configured to receive the N modulated quantum signals transmitted by a respective transmitter 110.

When the splitter 130 receives one of the modulated quantum signals from another splitter 130, the modulated quantum signal is actually a modulated quantum sub-signal; however, this is not limiting in this disclosure and thus any modulated quantum signal or any modulated quantum sub-signal received by each of the one or more splitters 130 may be understood as a received modulated quantum signal.

In other words, each splitter 130 may combine (i.e., split or merge) the N received modulated quantum signals into M output optical paths.

Further, each splitter 130 is configured to provide one or more of the M modulated quantum sub-signals to a respective receiver 120 and/or to another splitter 130.

Each receiver 120 of the plurality of receivers 120 is configured to receive, via a respective quantum channel, a modulated quantum sub-signal associated to one or more of the plurality of transmitters 110 from the one or more splitters 130.

Thereby, each receiver 120 may be optically coupled to one or more of the plurality of transmitters 110 via one or more of the splitters 130.

Next, each receiver 120 is configured to detect one or more quadrature components of the received modulated quantum sub-signal.

For example, each receiver 120 may comprise a homodyne detector or a heterodyne detector (not shown) for performing the detection of the one or more quadrature components of the received modulated quantum sub-signal.

Further, each receiver 120 is configured to perform a respective post-processing protocol with one or more of the plurality of transmitters 110 to generate one or more individual final secret keys between each of the one or more transmitters 110 and the receiver 120 based on the detected one or more quadrature components. Additionally or alternatively, the receiver 120 is configured to perform a respective post-processing protocol with one or more of the plurality of transmitters 110 to generate one or more common secret keys between the one or more transmitters 110 and the plurality of receivers 120 based on the detected one or more quadrature components.

Each of the one or more post-processing protocols comprises a QKD post-processing. Each QKD post-processing comprises one or more of: a parameter estimation stage, a sifting stage, a symbol mapping stage, an information reconciliation stage, and a privacy amplification stage.

In an embodiment, each splitter 130 comprises a plurality of N×M ports 131, where N≥1 and M≥2 or where N≥2 and M≥1. That is, the plurality of ports of each splitter 130 satisfy a relation max(N, M)≥2. Each of the N×M ports 131 is configured to act simultaneously as an input port and as an output port, thereby enabling a bi-directional optical communication between the splitter 130 and each of the plurality of receivers, and also a bi-directional optical communication between the splitter 130 and the one or more transmitters 110 and/or the one or more other splitters 130.

Each of the plurality of ports 131 of each splitter 130 may not directly connect to one of the transmitters 110 or to one of the receivers 120, but can connect to a port 131 of another splitter 130. In this way, a modulated quantum signal transmitted by one of the transmitter 110 may pass over one or more of the splitters 130 before reaching one of the receivers 120.

For example, the modulated quantum signal originating from a transmitter 120 may be at least partially transmitted through an output path 131 depicted in the top, right side of the first splitter 130 (from left to right) of FIG. 1, and may reach the second splitter 130. The signal may further pass to the third splitter 130 and finally may reach a receiver 120 on the right side of said third splitter 130. This allows dynamic interconnections of multiple transmitters 110 and multiple receivers 120 without the need to directly connecting the plurality of transmitters 110 and the plurality of receivers 120 to a single splitter 130.

In an embodiment, each transmitter 110 is configured to transmit a respective synchronization signal to one or more of the plurality of receivers 120 through the one or more splitters 130. Each synchronization signal may comprise frequency and/or phase information about the modulated quantum signal. Further, each synchronization signal may be, for example, a pilot tone.

Each transmitter 110 is further configured to transmit the respective synchronization signal together with the modulated quantum signal. Thereby, one or more of the plurality of receivers 120 may receive, via the one or more splitters 130, the synchronization signal associated to one or more of the transmitters 110.

Each synchronization signal may keep the respective transmitter 110 and one or more of the plurality of receivers 120 in sync with each other. By using one or more passive splitters 130, each synchronization signal may be constantly active between the respective transmitter 110 and the one or more receivers 120, keeping them in sync all the time.

For example, each synchronization signal transmitted by a respective transmitter 110 may occupy one DWDM channel and may be composed of the modulated quantum optical signal (of the respective transmitter 110) in one frequency band of the DWDM channel and a pilot tone signal in another frequency band within the DWDM channel. In addition, another classical signal in another frequency band within the DWDM channel may be added to convey auxiliary information such as an ID of a key. The N incoming signals to each splitter 130 may use the same DWDM channel(s) or may use different DWDM channels.

Then, one receiver 120 connected to the splitter 130 may be tuned to a particular DWDM channel and may receive the signal in that channel, which may result from a combination of multiple signals transmitted by multiple transmitters 110. The receiver 120 may then extract the synchronization signal corresponding to one of the transmitters 110 and a QKD signal (i.e., the received modulated quantum sub-signal) associated to the transmitter 110 to perform a QKD protocol with that transmitter 110. The receiver 120 may repeat this procedure with one or more of the transmitters 110.

In an embodiment, the CV-QKD system 100 further comprises a controller configured to control the operation of the plurality of transmitters 110, the plurality of receivers 120 and the one or more splitters 130.

The controller may oversee which of the transmitters 110 are supposed to connect to which of the receivers 120 and may facilitate the establishment of reconciliation channels between the plurality of transmitters 110 and the plurality of receivers 120.

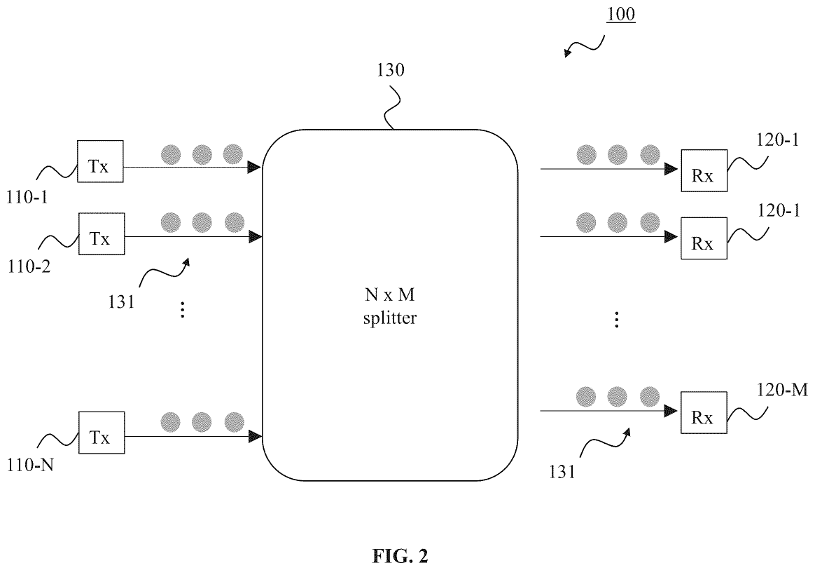

FIG. 2 is a schematic view of an exemplary embodiment of a CV-QKD system 100 according to this disclosure. Same elements are labelled with the same reference signs.

The CV-QKD system 100 of FIG. 2 is similar to the CV-QKD system 100 of FIG. 1 and the afore-detailed description may be applied to CV-QKD system 100 of FIG. 2, except for the hereinafter-mentioned noticeable differences.

In this exemplary embodiment, only one splitter 130 is shown for the sake of clarity. The splitter 130 is configured to receive the N modulated quantum signals respectively from N transmitters, exemplary transmitters 120-1, 120-2, . . . , 120-N. Further, the splitter 130 is configured to provide M modulated quantum sub-signals respectively to M receivers, exemplary receivers 120-1, 120-2 . . . , 120-M.

Thereby, the N incoming transmitter signals are split by the splitter 130 into M output optical paths.

This enables to perform QKD protocols among multiple parties interconnected by the N×M splitters, and allows dynamic grouping of QKD parties (i.e., transmitters and receivers) without the need to implement an active physical layer control.

The dots in FIG. 2 represent a modulated quantum signal transmitted by one transmitter 110 and reaching the splitter 130 and/or a modulated quantum sub-signal obtained by the splitter 130 associated to a modulated quantum signal transmitted of a respective transmitter 110 and that reaches a receiver 120.

For example, a modulated quantum signal transmitted by the transmitter 110-1 may be split by the splitter 130 into M modulated quantum sub-signals. Thus, at least a part of the modulated quantum signal transmitted by the transmitter 110-1 may be comprises in a modulated quantum sub -signal reaching the M receivers 120, for example receiver 120-1.

In an embodiment, the CV-QKD system 100 comprises at least two transmitters 120 and a plurality of receivers 120. Further, each splitter 130 is configured to distribute the N modulated quantum signals received from the at least two transmitters 120 into M modulated quantum sub-signals, with N≥2 and M≥2. That is, each of the at least two transmitters 120 may be optically coupled to at least two receivers 120.

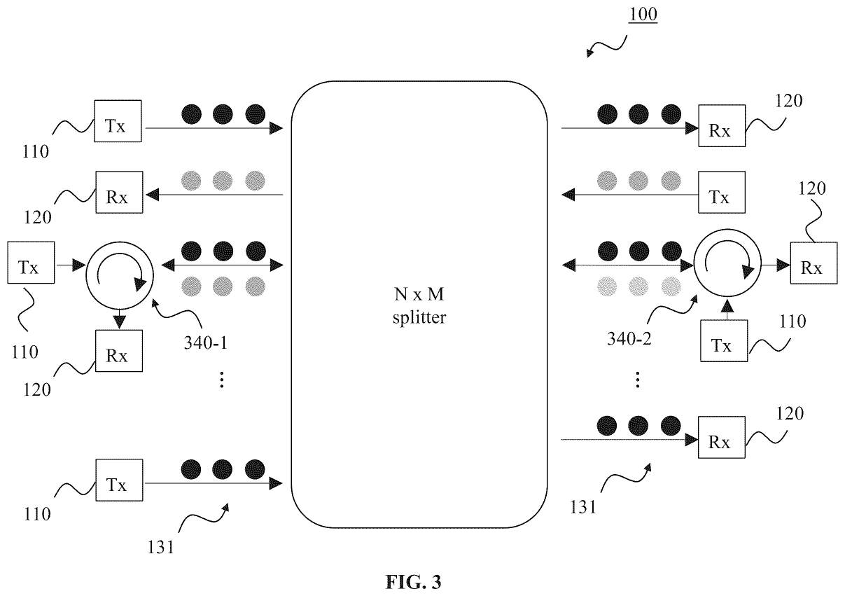

FIG. 3 is a schematic view of an exemplary embodiment of a CV-QKD system 100 according to this disclosure. Same elements are labelled with the same reference signs.

The CV-QKD system 100 of FIG. 3 is similar to the CV-QKD system 100 of FIG. 1 and FIG. 2, and the afore-detailed description may be applied to CV-QKD system 100 of FIG. 3, except for the hereinafter-mentioned noticeable differences.

In FIG. 3 one splitter 130 is shown for the sake of clarity. In this exemplary embodiment, one or more of the N×M ports 131 of each splitter 130 is further coupled to a circulating unit, exemplary units 340-1 and 340-2. Each circulating unit 340-1, 340-1 is configured to provide a modulated quantum sub-signal received from the one or more ports 131 to one of the plurality of receivers 120 or to another splitter 130.

Additionally or alternatively, the circulating unit may be further configured to provide a modulated quantum signal or a modulated quantum sub-signal transmitted to the one or more ports from one of the plurality of transmitters or from another splitter, respectively.

The splitter 130 according to this disclosure, shown in FIG. 3, may comprise a first set of nodes on the left side and a second set of nodes in the right side. A node may comprise a transmitter 110 or a receiver 120 of the CV-QKD system 100, and each set of nodes may comprise one or more transmitters 110 and/or one or more receivers 120.

In contrast to this disclosure, a conventional optical splitter features two set of nodes in which a signal sent from a node of one set only goes to a node in the other set.

Referring to FIG. 3, in the first line (from top to bottom), a first modulated quantum signal may be transmitted by a transmitter 120 on the left side of the splitter 130 (that is, in the first set of nodes) and may arrive at a receiver 120 in the first line of the right side (i.e., in the second set of nodes). On the second line, a second modulated quantum signal may be transmitted by a transmitter 110 on the right and may arrive at a receiver 120 on the left. Thereby, a bi-direction communication setting is provided by the CV-QKD system 100.

While each port 131 in the above-mentioned two lines may carry a signal in one direction (either left to right, or right to left), in the third line of FIG. 3 a port 131 in the left and in the right may carry a signal in both directions. Each of these two ports in the third line may be connected to a circulating unit (or circulator) 340-1 and 340-2 respectively, each circulating unit 340-1, 340-2 being connected to a transmitter 110 and a receiver 120. The modulated quantum signal transmitter by a transmitter 110 in the left side may enter the circulating unit 340-1 (also in the left), may reach one port 131 of the splitter 130 on the left and, after being distributed (split or merged) in the splitter 130, may further arrive at another port in the third line on the right. Then, it may enter the circulating unit 340-2 in the right side, which in turn may feed the respective modulated quantum sub-signal to a receiver 120 in the second set of nodes. A similar situation may occur for a modulated quantum signal transmitted by one of the transmitters 110 on the right entering the circulating unit 340-2 and then the splitter 130. Accordingly, dynamic interconnections of multiple transmitters 110 and multiple receivers 120 are allowed with different communication directions.

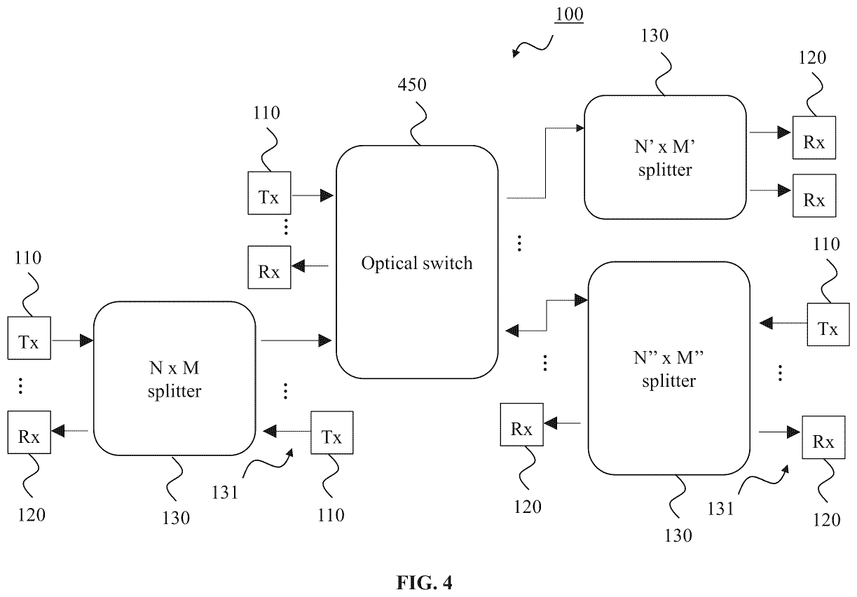

FIG. 4 shows a schematic view of an exemplary embodiment of the CV-QKD system 100 according to this disclosure that builds on the exemplary embodiment of FIG. 1. Same elements are labelled with the same reference signs.

The CV-QKD system 100 of FIG. 4 is similar to the CV-QKD system 100 of FIG. 1, FIG. 2 and FIG. 3, and the afore-detailed description may be applied to the CV-QKD system 100 of FIG. 4, except for the hereinafter-mentioned differences.

In this exemplary embodiment, the CV-QKD system 100 further comprises one or more optical switches 450.

Each of the one or more optical switches 450 is configured to receive one or more modulated quantum signals from a respective transmitter 110, additionally or alternatively one or more modulated quantum sub-signals from one or more of the splitters 130.

Then, each optical switch 450 is further configured to direct each of the one or more received modulated quantum signals and/or each of the one or more received modulated quantum sub-signals to one of the plurality of receivers 120 or to another splitter 130.

Alternatively, each optical switch 450 may be further configured to direct each of the one or more received modulated quantum signals and/or each of the one or more received modulated quantum sub-signals to another switch 450.

Each optical switch 450 may comprise one or more input ports and one or more output ports.

Further, each optical switch 450 can establish direct optical paths between selected ports of the switch, without splitting the signal entering a port. For example, in FIG. 4, a modulated quantum signal transmitted by a respective transmitter 110 from the left side may enter the first splitter 130 (from left to right) on the left side, where it is distributed by the first splitter 130, and a part of the modulated quantum signal, i.e., a respective modulated quantum sub-signal, may be provided by the first splitter 130 to the optical switch 450.

Then, the optical switch 450 may direct the modulated quantum sub- signal received from the direst splitter 130 to one of the two splitters 130 on the right.

Thereby, dynamic interconnections of multiple transmitters 110 and multiple receivers 120 are allowed with flexibility in constructing sophisticated networks with different optical devices, such as splitters 130 and switches 450.

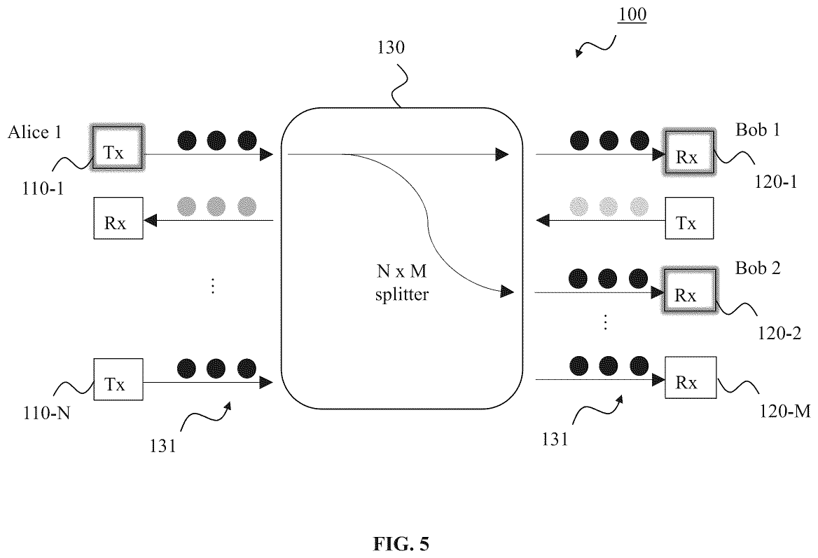

FIG. 5 shows a schematic view of an exemplary embodiment of the CV-QKD 100 according to this disclosure. Same elements are labelled with the same reference signs.

The CV-QKD system 100 of FIG. 5 is similar to the CV-QKD system 100 of FIG. 1, FIG. 2, FIG. 3 and FIG. 4, and the afore-detailed description may be applied to the CV-QKD system 100 of FIG. 5, except for the hereinafter-mentioned differences.

In the exemplary embodiment of FIG. 5, at least two receivers 120, exemplary receivers 120-1 and 120-2 receive, from the one or more splitters 130, a respective modulated quantum sub-signal associated to at least one of the transmitters 110, exemplary transmitter 110-1. In FIG. 5, only one splitter 130 is shown for the sake of clarity.

In this embodiment, the respective post-processing protocol to generate one or more individual final secret keys comprises the following: The at least one transmitter 110-1 and a first receiver, exemplary receiver 120-1, generate a first individual final secret key between them, i.e., between the transmitter 110-1 and the receiver 120-1, by performing a first QKD post-processing.

In the first QKD post-processing, a part of the modulated quantum signal transmitted by the transmitter 110-1 that is distributed by the one or more splitters 130 into the respective modulated quantum sub-signal that is received by a second receiver 120-2 (that is, a part of the modulated quantum signal of the transmitter 110-1 that does not reach the first receiver 120-1) is considered to be lost to an eavesdropper (not shown).

Then, the transmitter 110-1 and the second receiver 120-2 generate a second individual final secret key between them (i.e., between the transmitter 110-1 and the receiver 120-2) by performing a second QKD post-processing.

In the second QKD post-processing, a part of the modulated quantum signal from the transmitter 110-1 that is distributed by the one or more splitters 130 into the respective modulated quantum sub-signal that is received by the first receiver 120-1 (that is, a part of the modulated quantum signal of the transmitter 110-1 that does not reach the second receiver 120-2) is considered to be lost to the eavesdropper.

That is, the modulated quantum signal of Alice 1 (i.e., transmitter 110-1,) may be split by the splitter 130 and may reach both Bob 1 and Bob 2 (i.e., receiver 120-1 and receiver 120-2 respectively), while there may be other on-going modulated quantum signals propagating in the other optical paths in the splitter 130.

In this exemplary embodiment, an individual key between Alice 1 and Bob 1 and another individual key between Alice 1 and Bob 2 may be established.

Each individual key with one Bob 120-1 or 120-2 should be secure against the other Bob 120-2 or 120-1 respectively, as well as against the eavesdropper or Eve.

A naïve approach can be taken to establish these two individual keys. Alice 1 and Bob 1 may perform a conventional QKD post-processing, comprising independent parameter estimation. From Alice 1's and Bob 1's point of view, an amount of energy not received by Bob 1 (including the part that is received by Bob 2) is assumed to have gone to Eve. In this basis, Alice 1 and Bob 1 may generate a secure individual key between them.

Further, Alice 1 and Bob 2 may perform a conventional QKD post- processing comprising independent parameter estimation, in a similar manner.

Alternatively, in the exemplary embodiment of FIG. 5, the respective post-processing protocol to generate one or more individual final secret keys comprises the following: Each of the first receiver 120-1 and the second receiver 120-2 sends to the transmitter 110-1, for example via a respective secure classical channel, one or more respective data samples that are taken from the respectively received modulated quantum sub-signal.

Then, the transmitter 110-1 collectively estimates a first quantum channel of the first receiver 120 and a second quantum channel of the second receiver 120.

Further, the transmitter 110-1 and the first receiver 120-1 generate the first individual final secret key between them by performing a third QKD post-processing on the estimated first quantum channel.

Next, the first transmitter 110-1 and the second receiver 120-2 generate the second individual final secret key between them by performing a fourth QKD post-processing on the estimated second quantum channel.

Each QKD post-processing comprises one or more of: a parameter estimation stage, a sifting stage, a symbol mapping stage, an information reconciliation stage, and a privacy amplification stage.

In other words, this exemplary embodiment provides an alternative approach to establish individual keys by enabling Alice 1, Bob 1 and Bob 2 to perform a joint parameter estimation on their respective channels. For example, Bob 1 and Bob 2 may each send some data samples of their respective received modulated quantum sub-signals to Alice 1. Then, Alice 1 may collectively estimate the respective channels of Bob 1 and Bob 2.

From Bob 1's perspective, a part of Alice 1's modulated quantum signal that went to Bob 2 did not go to Eve. Thereby, Eve's information on the key data related to Alice 1 and Bob 1 may be estimated more accurately.

In this embodiment, Bob 2 may be considered as a trusted and cooperating party with respect to assisting Alice 1 and Bob 1 to generate their individual key. In order to ensure that said individual key is secure against Eve and against Bob 2, both Alice 1 and Bob 1 may perform privacy amplification by taking into account Eve's information on the key data related to Alice 1 and Bob 1 and taking into account Bob 2's information on the key data related to Alice 1 and Bob 1.

Thereby, Bob 1 may be considered as a trusted and cooperating party with respect to assisting Alice 1 and Bob 2 to generate their individual key, and Alice 1 and Bob 2 may perform privacy amplification to ensure that their individual key is secure against Eve and against Bob 1.

A rate of each of the first individual key and the second individual key between Alice 1-Bob 1 and Alice 1-Bob 2 respectively, may be higher compared to a case where no joint parameter estimation is used.

Dynamic interconnections of multiple transmitters 110 and multiple receivers 120 are allowed with the possibility to efficiently establish individual keys between at least one transmitter 110-1 and each of at least two receivers 120-1, 120-2.

Referring to the exemplary embodiment of FIG. 5, a common final secret key can also be established. The respective post-processing protocol to generate one or more common final secret keys comprises the following: After the at least one transmitter 110-1 collectively estimates the first quantum channel of the first receiver 120-1 and the second quantum channel of the second receiver 120-1, the transmitter 110-1 and each of the at least two receivers 120-1, 120-2 perform forward information reconciliation and further establish a common key between the transmitter 110-1 and the at least two receivers 120-1, 120-2, i.e., a common key between the transmitter 110-1, the first receiver 120-1 and the second receiver 120-2.

Then, the transmitter 110-1 and the at least two receivers 120-1, 120-2 distill a final common secret key between them by using a post-selection method.

That is, Alice 1, Bob 1 and Bob 2 may perform a joint parameter estimation on their channels. For example, Bob 1 and Bob 2 may each send one or more data samples of the respectively received modulated quantum sub-signal to Alice 1, and Alice 1 may collectively estimate the first channel of Bob 1 and the second channel of Bob 2.

A part of Alice's modulated quantum signal that did not go to Bob 1 and Bob 2, from the one or more splitters 130, is considered to have gone to Eve. Thereby, Eve's information on the key data related to Alice, Bob 1 and Bob 2 can be estimated more accurately.

Further, Alice 1, Bob 1 and Bob 2 may perform forward reconciliation to establish a common key between them.

In the forward reconciliation, Alice 1's data may be considered to be correct, and Bob 1 and Bob 2 may correct their respective data to match that of Alice 1. Then, Alice 1, Bob 1 and Bob 2 may perform a post-selection method to increase a reach (i.e. greater distance or higher loss) for which the common key can be established.

The post-selection method may comprise that each Bob 1 and Bob 2 may decide to keep the data in the respectively received modulated quantum sub-signal if their respective data has an amplitude or energy that exceeds a certain threshold. Alice 1, Bob 1 and Bob 2 then may coordinate and may distill the final common key by using only the data that is kept by both Bob 1 and Bob 2. Such a post-selection method may affect Eve's information on the key data related to Alice 1, Bob 1 and Bob 2 and, thus, Eve's information may be taken into account when distilling the final common key.

Dynamic interconnections of multiple transmitters 110 and multiple receivers 120 are allowed with the possibility to efficiently establish common keys between multiple transmitters 110 and multiple receivers 120, where each common key is shared between at least three parties.

In general, it is to be noted that in the CV-QKD system 100 according to this disclosure, which comprises one or more splitters 130 and one or more optical switches 340, there may be individual keys established by pairs of parties and common keys established by groups of parties.

Alternatively, in an embodiment, the respective post-processing protocol to generate one or more common final secret keys comprises the following: The at least one transmitter 110-1 generates a random string having a length equal to a length of the first individual final secret key between the transmitter 110-1 and the first receiver 120-1.

Then, the transmitter 110-1 generates a first encrypted string by encrypting the random string using the first individual final secret key. Further, the transmitter 110-1 generates a second encrypted string by encrypting the random string using the second individual final secret key.

Further, the transmitter 110-1 sends the first encrypted string to the first receiver 120-1 and the second encrypted string to the second receiver 120-2.

Next, each of the first receiver 120-1 and the second receiver 120-2 obtains a respective final common secret key between the transmitter 110-1 and the at least two receivers 120-1, 120-2 by decrypting the respectively received first encrypted string and the second encrypted string. The final common secret key comprises the random string generated by the transmitter 110-1.

In other words, suppose that Alice 1 and Bob 1 have generated a key K between them and that Alice 1 and Bob 2 have generated a key K′ between them, where it may be further assumed K and K′ have the same length. Then, to generate a common key among Alice 1, Bob 1 and Bob 2, they can proceed as follows.

Alice 1 can generate a random string R of the same length as K or K′. Then, Alice 1 may send a result of XORing R and K (i.e. a result of encrypting R with the key K) to Bob 1 and may send a result of XORing R and K′ (i.e. a result of encrypting R with key K′) to Bob 2.

Bob 1 may decrypt his received result by XORing it with K to get R. Similarly, Bob 2 may decrypt his received result by XORing it with K′ to get R. Thereby, the at least three parties Alice 1, Bob 1 and Bob 2 may have the same key R.

Alternatively, in an embodiment, the respective post-processing protocol to generate one or more common final secret keys comprises that the transmitter 110-1 generates an encrypted string by encrypting the first individual final secret key using the second individual final secret key. Next, the transmitter 110-1 sends the encrypted string to the second receiver 120-2.

Then, the second receiver 120-2 obtains the final common key between the transmitter 110-1 and the at least two receivers 120-1, 120-2 by decrypting the received encrypted string using the second individual final secret key and further extracting the first individual final secret key from the decrypted encrypted string. In this embodiment, the final common key between the transmitter 110-1 and the at least two receivers 120-1, 120-2 comprises the first individual final secret key.

For example, Alice 1 may send an XOR result of K and K′ (i.e. a result of encrypting K with key K′) to Bob 2. Next, Bob 2 may decrypt its received result by XORing it with K′. Thereby, Bob 2 can get K and, thus, Alice 1, Bob 1 and Bob 2 can have the same key K.

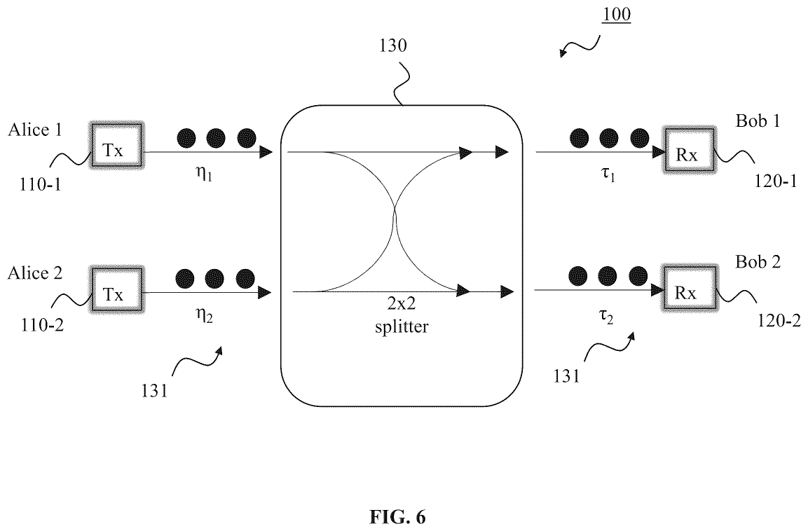

FIG. 6 shows a schematic view of an exemplary embodiment of the CV-QKD 100 according to this disclosure. Same elements are labelled with the same reference signs.

The CV-QKD system 100 of FIG. 6 is similar to the CV-QKD system 100 of FIG. 1, FIG. 2, FIG. 3, FIG. 4 and FIG. 5, and the afore-detailed description may be applied to the CV-QKD system 100 of FIG. 6, except for the hereinafter-mentioned differences.

In the exemplary embodiment of FIG. 6, one or more splitters 130 interconnect multiple transmitters 110 and multiple receivers 120, where each of at least two receivers 120, exemplary receivers 120-1 and 120-2, receive, from the one or more splitters 130, a respective modulated quantum sub-signal associated to at least two transmitters 110 of the plurality of transmitters 110, exemplary transmitters 110-1 and 110-2, while there may be other on-going signal propagation in the other optical paths in the splitter. For the sake of clarity, only the transmitters 110-1 and 110-2, the two receivers 120-1 and 120-2 and one splitter 130 are shown in FIG. 6. This does not limit this embodiment, as the plurality of transmitters 110, the plurality of receivers, more splitters 130 and/or the one or more optical switches may be comprised in the CV-QKD system 100.

For example, the one or more splitters 130 may be 2×2 splitters 130, as depicted in FIG. 6.

Then, the respective post-processing protocol to generate one or more individual final secret keys comprises a process explained in the following. Each of the at least two transmitters 110-1, 110-2 and a first receiver 120-1 generate a respective individual final secret key between the transmitter 110-1, 110-2 and the first receiver 120-1 by performing a respective QKD post-processing. In the respective QKD post-processing, a part of the modulated quantum signal transmitted from each transmitter 110-1, 110-2 that is distributed by the one or more splitters 130 and that is received by the second receiver 120-2 in the respective modulated quantum sub-signal, is considered to be lost to an eavesdropper (not shown).

Then, each transmitter 110-1, 110-2 and the second receiver 120-2 generate a respective individual final secret key between them (that is, between the transmitter 110-1 or 110-2 and the second receiver 120-2) by performing a respective QKD post-processing, where a part of the modulated quantum signal transmitted from each transmitter 110-1, 110-2 and distributed by the one or more splitters 130 that is received by the first receiver 120-1 in the respective modulated quantum sub-signal, is considered to be lost to the eavesdropper.

In other words, a modulated quantum signal of Alice 1 (i.e., transmitter 110-1) is split, by the splitter 130, into at least two quantum sub-signals. Each quantum sub-signal reaches Bob 1 (receiver 120-1) and Bob 2 (receiver 120-2) respectively. In addition, a modulated quantum signal of Alice 2 (i.e., transmitter 110-2) is split by the one or more splitters 130 into at least two quantum sub-signals, each quantum sub-signal reaching Bob 1 and Bob 2, respectively.

Thereby, at least four individual keys can be generated, that is a key between Alice 1 and Bob 1, a key between Alice 1 and Bob 2, a key between Alice 2 and Bob 1, and a key between Alice 2 and Bob 2. Each key with one Bob 120-1, 120-2 should be secure against the other Bob 120-2, 120-1 and against Eve.

A naïve approach can be taken to establish these individual keys. Alice 1 and B1 may perform a conventional QKD post-processing, comprising independent parameter estimation. From Alice 1's and Bob 1's point of view, an amount of energy that is not received by Bob 1, which may comprise the part comprised in the modulated quantum sub-signal received by Bob 2, is assumed to have gone to Eve. Then, on this basis, Alice 1 and Bob 1 may generate a secure individual key between them.

In a similar manner, Alice 1 and Bob 2, Alice 2 and Bob 1, and Alice 2 and B2 may perform a conventional QKD post-processing, comprising independent parameter estimation.

Additionally or alternatively, in the exemplary embodiment of FIG. 6, each of the at least two transmitters 110-1, 110-2 are configured to transmit the respective modulated quantum signal through the one or more splitters 130 using time multiplexing, and either a first transmitter 110-1 or a second transmitter 110-2 is configured to transmit the respective modulated quantum signal at one time.

Accordingly, each of the at least two receivers 120-1, 120-2 is configured to receive the respective modulated quantum sub-signal associated with each of the at least two transmitters 110-1, 110-2 at one time.

Then, the respective post-processing protocol to generate one or more individual final secret keys comprises the following: Each receiver 120-1, 120-2 sends to each transmitter 110-1, 110-2, via a respective secure classical channel, one or more respective data samples taken from the respective modulated quantum sub-signal.

Then, each transmitter 110-1, 110-2 collectively estimates a first quantum channel of the first receiver 1201 and a second quantum channel of the second receiver 120-2.

Further, each transmitter 110-1, 110-2 and the first receiver 120-1 generate a respective individual final secret key between the transmitter 110-1, 110-2 and the first receiver 120-1 by performing a respective QKD post-processing on the respective estimated first quantum channel.

Each transmitter 110-1, 110-2 and the second receiver 120-2 then generate a respective individual final secret key between the transmitter 110-1, 110-2 and the second receiver 120-2 by performing a respective QKD post-processing on the respective estimated second quantum channel.

That is, Alice 1, Bob 1 and Bob 2 may perform a joint parameter estimation on the first and the second channels. For example Bob 1 and Bob 2 may each send some data samples of the respectively received modulated quantum sub-signal to Alice 1, and Alice 1 collectively estimates the first channel of B1 and the second channel of Bob 2.

Similarly, Alice 2, Bob 1 and Bob 2 may perform a joint parameter estimation on the first and second channels.

For example, a modulated quantum signal transmitted by one Alice i may reach one Bob j with a transmittance of ηᵢτⱼ/2, where ηᵢ is a transmittance experienced by a modulated quantum signal received by input port i of each splitter 130 where the transmittance is induced by the optical path between Alice i and the input port i, and τⱼ is a transmittance experienced by a modulated quantum sub-signal provided by output port j of the splitter 130 where the transmittance is induced by the optical path between the output port j and Bob j. The respective transmittances η₁, η₂, τ₁, and τ₂ are depicted in FIG. 6. It is assumed that the factor of half in the transmittance ηᵢτj/2 comes from the splitting ratio of the splitter 130.

Further, a fraction (1−η₁) and (1−η₂) of the modulated quantum signal transmitted by Alice 1 and Alice 2 respectively, and a fraction (1−τ₁) and (1−τ₂) of the modulated quantum sub-signals received respectively by Bob 1 and Bob 2 may have gone to Eve.

Thus, tightly estimating these four parameters η₁, η₂, τ₁, and τ₂ may allow to estimate Eve's information on the key data related to Alice 1, Alice 2, Bob 1 and Bob 2, tightly. It may also be possible to enable Alice 1, Alice 2, Bob 1 and Bob 2 to perform a joint parameter estimation to better estimate these parameters.

A key rate of each of the four QKD sessions explained above (in this disclosure, a QKD session is a procedure consisting of quantum state transmission and QKD post-processing, with the goal of distilling a QKD key) may reflect that the four obtained individual keys may be higher compared to a case where no joint parameter estimation is used.

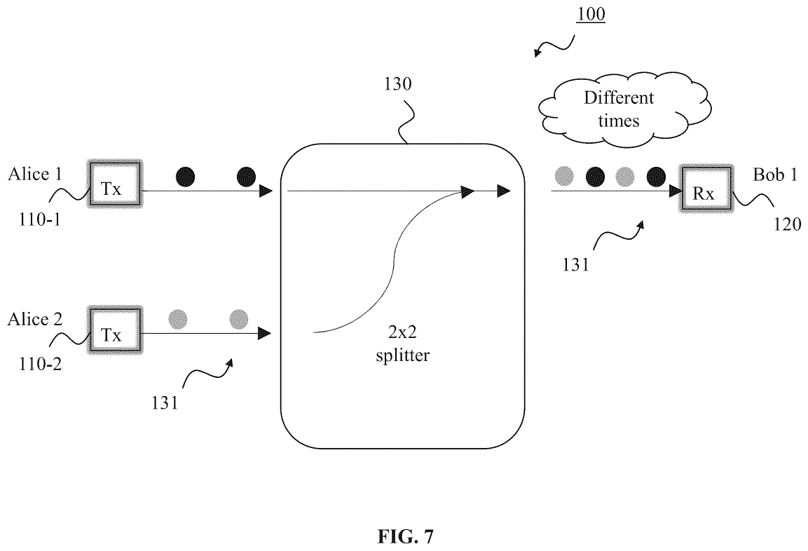

FIG. 7 shows a schematic view of an exemplary embodiment of the CV-QKD 100 according to this disclosure. Same elements are labelled with the same reference signs.

The CV-QKD system 100 of FIG. 7 is similar to the CV-QKD system 100 of FIG. 1, FIG. 2, FIG. 3, FIG. 4, FIG. 5 and FIG. 6, and the afore-detailed description may be applied to the CV-QKD system 100 of FIG. 7, except for the hereinafter-mentioned differences.

In this exemplary embodiment, one or more splitters 130 interconnect multiple transmitters 110 and multiple receivers 120, where at least one receiver 120 receives, from the one or more splitters 130, a respective modulated quantum sub-signal associated to at least two transmitters, exemplary transmitters 110-1 and 110-2, while there may be other on-going signal propagation in the other optical paths in the one or more splitters 130. For the sake of clarity, only the transmitters 110-1 and 110-2, the receiver 120 and one splitter 130 are shown in FIG. 7. This does not limit this embodiment, as the plurality of transmitters 110, the plurality of receivers, more splitters 130 and/or the one or more optical switches may be comprised in the CV-QKD system 100.

Each of the at least two transmitters 110-1, 110-2 are configured to transmit the respective modulated quantum signal through the one or more splitters 130 using time multiplexing.

In this embodiment, the respective post-processing protocol to generate one or more individual final secret keys comprises the following. The receiver 120 receives the respective modulated quantum sub-signal associated to each of the at least two transmitters 110 from the one or more splitters 130 at a different time.

Then, each transmitter 110-1, 110-2 and the receiver 120 perform a respective QKD post-processing to generate a respective individual final secret final key between each transmitter 110-1, 110-2 and the receiver 120, that is between a first transmitter 110-1 and the receiver 120 and between a second transmitter 110-2 and the receiver 120.

In other words, the modulated quantum signal of Alice 1 may be split by the one or more splitters 130 and may reach Bob 1. In addition, the modulated quantum signal of Alice 2 may be split by the one or more splitters 130 and may reach Bob 1.

In order to establish an individual key between Alice 1 and Bob 1, and an individual key between Alice 2 and Bob 1, the modulated quantum signals of Alice 1 and Alice 2 may be separated by using time multiplexing. Further, Alice 1 and Alice 2 may coordinate so that the modulated quantum sub-signals associated to each transmitter may arrive at Bob 1 at different times.

Then, Alice 1 and Bob 1 may perform an independent QKD post-processing to generate the independent key between them. Similarly, Alice 2 and Bob 1 may perform an independent QKD post-processing to form the independent key between them.

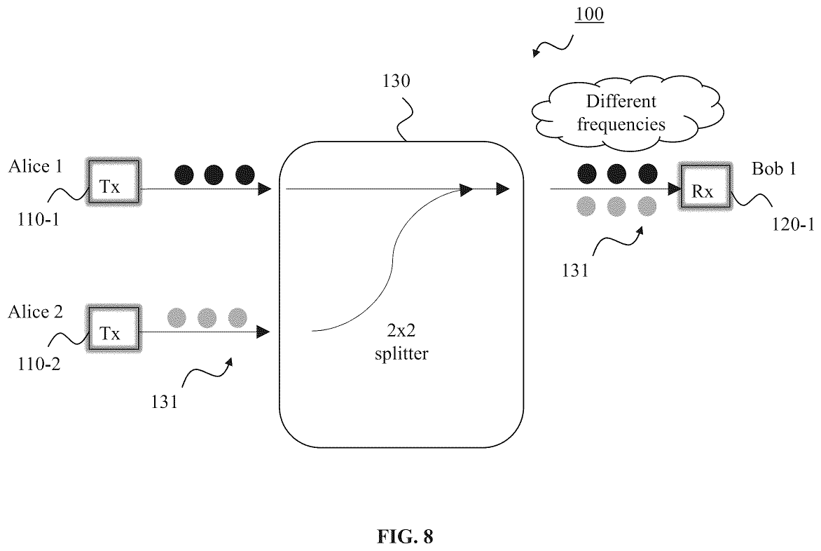

FIG. 8 shows a schematic view of an exemplary embodiment of the CV-QKD 100 according to this disclosure. Same elements are labelled with the same reference signs.

The CV-QKD system 100 of FIG. 8 is similar to the CV-QKD system 100 of FIG. 1, FIG. 2, FIG. 3, FIG. 4, FIG. 5, FIG. 6 and FIG. 7, and the afore-detailed description may be applied to the CV-QKD system 100 of FIG. 8, except for the hereinafter-mentioned differences.

In the exemplary embodiment of FIG. 8, one or more splitters 130 interconnect multiple transmitters 110 and multiple receivers 120, where at least one receiver 120 receives, from the one or more splitters 130, a respective modulated quantum sub-signal associated to at least two transmitters, exemplary transmitters 110-1 and 110-2, while there may be other on-going signal propagation in the other optical paths in the one or more splitters 130. For the sake of clarity, only the transmitters 110-1 and 110-2, the receiver 120 and one splitter 130 are shown in FIG. 8. This does not limit this embodiment, as the plurality of transmitters 110, the plurality of receivers, more splitters 130 and/or the one or more optical switches may be comprised in the CV-QKD system 100.

Each of the at least two transmitters 110-1, 110-2 may be configured to transmit the respective modulated quantum signal through the one or more splitters 130 using frequency multiplexing.

In this exemplary embodiment, the respective post-processing protocol to generate one or more individual final secret keys comprises the following. The receiver 120 receives the respective quantum sub-signal associated to each of the at least two transmitters 110-1, 110-2 at a different frequency.

Then, each transmitter 110-1, 110-2 and the receiver 120 perform a respective QKD post-processing to generate a respective individual final secret key between the transmitter 110-1, 110-2 and the receiver 120.

That is, the modulated quantum signal of Alice 1 may be split by the splitter 130 and may reach Bob 1, and the modulated quantum signal of Alice 2 may be split by the splitter 130 and may reach Bob 1, while there may be other on-going signal propagating in the other optical paths in the splitter 130.

An individual key between Alice 1 and Bob 1 and an individual key between Alice 2 and Bob 1 may be generated by separating the respective modulated quantum sub-signals of Alice 1 and Alice 2 using frequency multiplexing. Additionally, Alice 1 and Alice 2 may coordinate so that the respective associated quantum sub-signals arrive at Bob 1 at different frequencies.

Then, Alice 1 and Bob 1 may perform an independent QKD post-processing to form an independent key between them. Similarly, Alice 2 and Bob 1 perform an independent QKD post-processing to form an independent key between them.

This allows dynamic interconnections of multiple transmitters and multiple receivers with the possibility to efficiently establish individual keys between different pairs of transmitters and receivers.

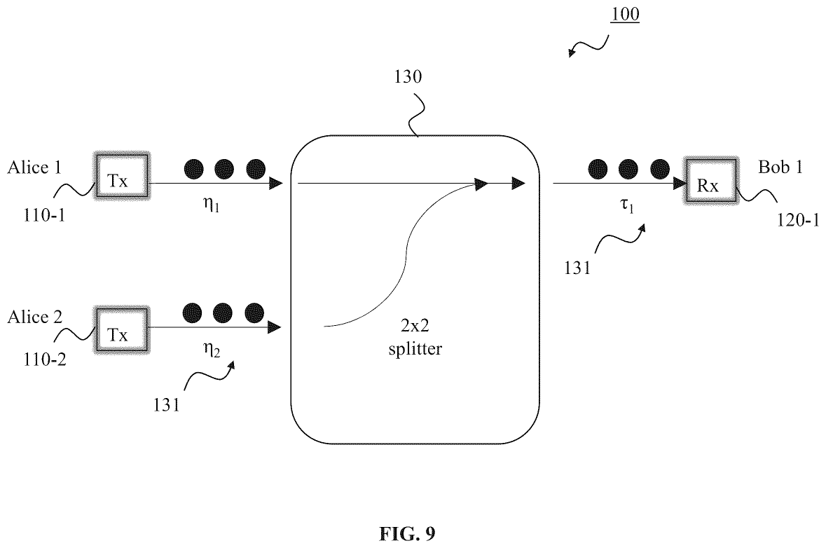

FIG. 9 shows a schematic view of an exemplary embodiment of the CV-QKD 100 according to this disclosure. Same elements are labelled with the same reference signs.

The CV-QKD system 100 of FIG. 9 is similar to the CV-QKD system 100 of FIG. 1, FIG. 2, FIG. 3, FIG. 4, FIG. 5, FIG. 6, FIG. 7 and FIG. 8, and the afore-detailed description may be applied to the CV-QKD system 100 of FIG. 9, except for the hereinafter-mentioned differences.

In the exemplary embodiment of FIG. 9, one or more splitters 130 interconnect multiple transmitters 110 and multiple receivers 120, where at least one receiver 120 receives, from the one or more splitters 130, a respective modulated quantum sub-signal associated to at least two transmitters, exemplary transmitters 110-1 and 110-2, while there may be other on-going signal propagation in the other optical paths in the one or more splitters 130. For the sake of clarity, only the transmitters 110-1, 110-2, the receiver 120 and one splitter 130 are shown in FIG. 9. This does not limit this embodiment, as the plurality of transmitters 110, the plurality of receivers, more splitters 130 and/or the one or more optical switches may be comprised in the CV-QKD system 100.

In this exemplary embodiment, the receiver 120 may be configured to receive a combined signal. The combined signal comprises the respective modulated quantum sub-signals associated to the at least two transmitters 110-1, 110-2 that is received by the receiver 120 at a same time and/or at a same frequency and/or at a same polarization.

The respective post-processing protocol to generate one or more individual final secret keys comprises a process explained in the following. The receiver 120 receives from the one or more splitters 130 the combined signal.

Then, the receiver 120 announces, the combined signal to the at least two transmitters 110-1, 110-2 via a respective classical secure channel.

Further, each of the at least two transmitters 110-1, 110-2 performs a respective QKD post-processing to generate an individual final secret key between them.

Additionally or alternatively, the respective post-processing protocol to generate one or more individual final secret keys comprises that a first transmitter 110-1 of the at least two transmitters announces its respective modulated quantum signal to a second transmitter 110-2 and to the receiver 120 via a respective classical secure channel.

Then, the receiver 120 determines a signal that comprises a noisy version of the modulated quantum sub-signal associated to the second transmitter 110-2 received from the one or more splitters 130.

Next, the second transmitter 110-2 and the receiver 120 perform a respective QKD post-processing to generate an individual final secret key between them.

In other words, in this exemplary embodiment, the modulated quantum signal of Alice 1 may be split, by the splitter 130 and may reach Bob 1, and the modulated quantum signal of Alice 2 may be split by the splitter 130 and may subsequently reach Bob 1, while there may be other on-going signals propagating in the other optical paths in the splitter 130.

An individual key between Alice 1 and Bob 1 and an individual key between Alice 2 and Bob 1 can be established. The modulated quantum signals of Alice 1 and Alice 2 are not multiplexed, but they may arrive at Bob 1 in a combination, i.e. they may arrive, for example and not as a limitation, at the same time and/or at the same frequency and/or at the same polarization.

If Alice 1's modulated quantum signal is a1 and Alice 2's modulated quantum signal is a2, then Bob 1 receives a noisy version of a1+a2. There may be two approaches to establish a key between pairs of the parties.

In a first approach, Bob 1 may announce the noisy version of a1+a2, so that Alice 1 and Alice 2 may perform a QKD post-processing to create a key between themselves, i.e., between Alice 1 and Alice 2. In this case, Bob 1 may be, or may act as, a trusted helper.

In a second approach, Alice 1 may announce a1 so that Bob 1 may get a noisy version of a2. Then, Bob 1 and Alice 2 may perform a QKD post-processing to create a key between them, i.e. between Bob 1 and Alice 2. In this case, Alice 1 may be, or may act as, a trusted helper.

This may allow dynamic interconnections of multiple transmitters and multiple receivers with the possibility to efficiently establish individual keys between different pairs of transmitters and receivers.

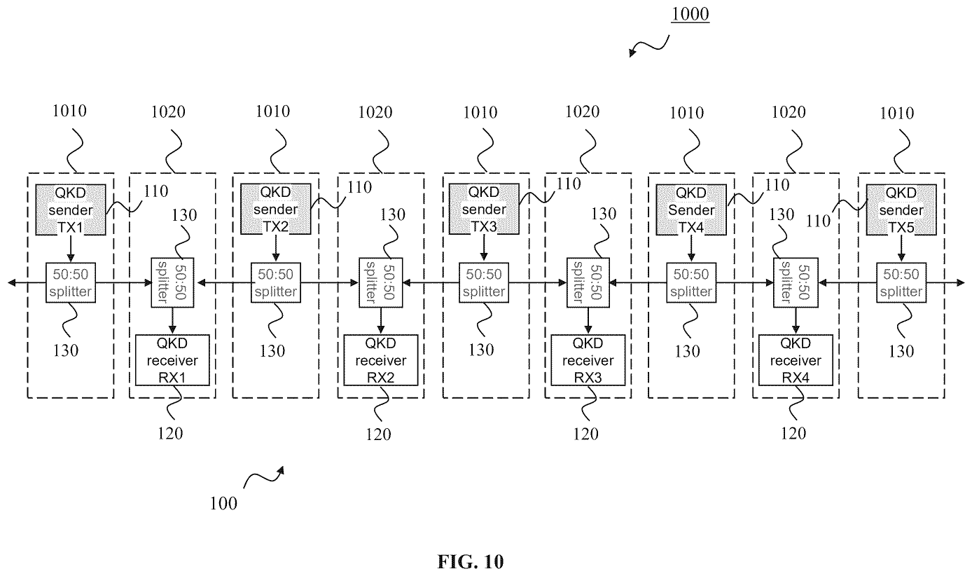

FIG. 10 schematically depicts an exemplary embodiment of an optical network 1000 comprising a CV-QKD system 100 according to this disclosure.

The CV-QKD system 100 of the optical network 1000 shown in FIG. 10 is similar to the CV-QKD system 100 of FIG. 1, FIG. 2, FIG. 3, FIG. 4, FIG. 5, FIG. 6, FIG. 7, FIG. 8 and FIG. 9, and the afore-detailed description may be applied to the CV-QKD system 100 of FIG. 10, except for the hereinafter-mentioned differences.

The CV-QKD system 100 shown in FIG. 10 comprises the plurality of transmitters 110, exemplary TX1 to TX5, the plurality of receivers 120, exemplary RX1 to RX4, and the one or more splitters 130 arranged forming a plurality of transmitting nodes 1010 and a plurality of receiving nodes 1020.

Each transmitting node 1010 comprises one transmitter 110 connected to a first splitter 130, and each receiving node 1020 comprises one receiver 120 connected to a second splitter 130.

The plurality of transmitting nodes 1010 and the plurality of receiving nodes 1020 are arranged in an alternating manner, so that each transmitting node 1010 has a neighbour receiving node 1020.

The first splitter 130 of each transmitting node 1010 is configured to receive a modulated quantum signal from the respective transmitter 110 of the transmitting node 1010, and the second splitter 130 of each receiving node 1020 is configured to receive a modulated quantum sub-signal from the respective first splitter 130 of two of the transmitting nodes 1010, for example of two neighbouring transmitting nodes 1010.

Thus, each transmitting node 1010 and each neighbour receiving node 1020 share the respective one transmitter 110 and the respective one receiver 120.

The receiver 120 of each receiving node 1020 receives from the respective second splitter 130 a modulated quantum sub-signal associated to two respective transmitters 110 of two neighbouring transmitting nodes 1010.

Each of the first splitters 130 may be, for example but not as a limitation, a 50:50 splitter, and each of the second splitters 130 may be, for example but not as a limitation, a 50:50 splitter.

Thereby, the optical network 1000 is a regular network structure with a linear topology.

The receiver 120 of each receiving node 1020 is configured to perform a respective post-processing protocol with the transmitter 110 of a respective neighbour transmitting node 1010 to generate an individual final secret key between the receiver 120 and a respective the transmitter 110 of each neighbour transmitting node 1010, i.e., between the receiver 120 and a transmitter 110 of a first neighbour transmitting node 1010, and between the receiver 120 and a transmitter 110 of a second neighbour transmitting node 1010.

The respective post-processing protocol to generate one or more individual final secret keys comprises generating an individual final secret key between a pair of distant nodes 1010, 1020, each node 1010, 1020 comprising one of the plurality of transmitting nodes 1010 or one of the plurality of the receiving nodes 1020. That is, each node of the pair of distant nodes may comprise a transmitting node 1010 or a receiving node 1020 and, thus, the individual final secret key may be established between two transmitters 110 of the respective pair of distant (transmitting) nodes 1010, or may be between two receivers 120 of the respective pair of distant (receiving) nodes 1020, or between a transmitter 110 and a receiver 120 of the respective pair of distant nodes 1010, 1020.

Generating the individual final secret key between the pair of distant nodes 1010, 1020 comprises generating, by a first transmitter 110 or a first receiver 120 of a first node 1010, 1020, a random key string to be shared between the first transmitter 110 or the first receiver 120 and a second transmitter 110 or a second receiver 120 of a second node 1010, 1020, where the first node 1010, 1020 and the second node 1010, 1020 are separated by one or more neighbour nodes 1010, 1020, each neighbour node 1010, 1020 comprising a receiving node 1020 or a transmitting node 1010.

Further, generating the individual final secret key between the pair of distant nodes 1010, 1020 comprises encrypting, by the first transmitter 110 or the first receiver 120, the random key using the individual final secret key between the first transmitter 110 or the first receiver 120 and the respective receiver 120 or transmitter 110 of a respective one neighbour node 1010, 1020, and sending the encrypted random key to the respective neighbour node 1010, 1020.

Then, generating the individual final secret key between the pair of distant nodes 1010, 1020 comprises obtaining, by the receiver 120 or the transmitter 110 of each neighbour node 1010, 1020, the random key string by decrypting the received encrypted random key using the individual final secret key between the transmitter 110 or the receiver 120 of each neighbour node 1010, 1020 and the respective receiver 120 or transmitter 110 of a previous neighbour node 1010, 1020.

Generating the individual final secret key between the pair of distant nodes 1010, 1020 further comprises encrypting, by the receiver 120 or the transmitter 110 of each neighbour node 1010, 1020, the random key using the individual final secret key between the transmitter 110 or the receiver 120 of the neighbour node 1020 and the respective receiver 120 or transmitter 110 of a next neighbour node 1010, and sending the encrypted random key to the respective next neighbour node 1010, 1020.

Therefrom, generating the individual final secret key between the pair of distant nodes 1010, 1020 comprises obtaining, by the second transmitter 110 or the second receiver 120 of the second node 1010, 1020, the random key string by decrypting the encrypted random key received from the respective previous neighbour node 1010, 1020 using the individual final secret key between the second transmitter 110 or the second receiver 120 and the respective receiver 120 or transmitter 110 of the respective previous neighbour node 1010, 1020.

In other words, each modulated quantum signal of a respective transmitter 120 of a transmitting node 1010 may be split by the respective first splitter 130 onto two quantum sub-signals, each modulated quantum sub-signal may be provided, from the first splitter 130, to one receiver 120 of a receiving node 1020 being neighbour to the transmitting node 1010.

Each receiver 120 of each receiving node 1020, thus, may receive two modulated quantum sub-signals, each associated to the modulated quantum signals transmitted respectively by two transmitters 110, each transmitter 110 belonging to a respective neighbour transmitting node 1010.

In this exemplary embodiment, one or more intermediate nodes 1010, 1020 may serve as trusted repeaters that assist in establishing individual keys between two other nodes 1010, 1020.

QKD sessions among the plurality of transmitters 110 and the plurality of receivers 120 may generate individual keys between pairs of transmitters 110 and receivers 120, for example, TX1 and RX1, between RX1 and TX2, between TX2 and RX2, between RX2 and TX3, between TX3 and RX3, between RX3 and TX4, between TX4 and RX4, and between RX4 and TX5.

As an example, consider TX1 and TX5 to establish a common key of their own by relying on RX1, TX2, RX2, TX3, RX3, TX4 and RX4 as trusted repeaters. One way to do this is by enabling TX1 to first generate a random key string, denoted as K, to serve as a key to be shared with TX5.

Then, TX1 may use one-time pad (OTP) to encrypt the key K with the individual key generated for TX1 and RX1, and may pass a result of the encryption to RX1. Then, RX1 may decrypt the encryption result with the key for TX1 and RX1. Thus, RX1 may recover the key K.

Therefrom, RX1 may similarly encrypt the recovered key K with the individual key for RX1 and TX2, and may subsequently pass a result of this encryption to TX2, which in turn may decrypt the encryption result with the key for TX2 and RX2. This procedure may be repeated along the one or more intermediate nodes 1010, 1020 until TX5 may obtain the key K. Thus, the key K may be shared between TX1 and TX5, that is, between the respective distant transmitting nodes 1010. This allows a minimal deployment of equipment over a chain of nodes.

The optical network according to this disclosure is not limited to the example above. That is, the disclosure provides an optical network comprising any one of the embodiments for the CV-QKD system 100 disclosed above and shown in FIG. 1, FIG. 2, FIG. 3, FIG. 4, FIG. 5, FIG. 6, FIG. 7, FIG. 8, FIG. 9 and FIG. 10, and their respective implementation forms.

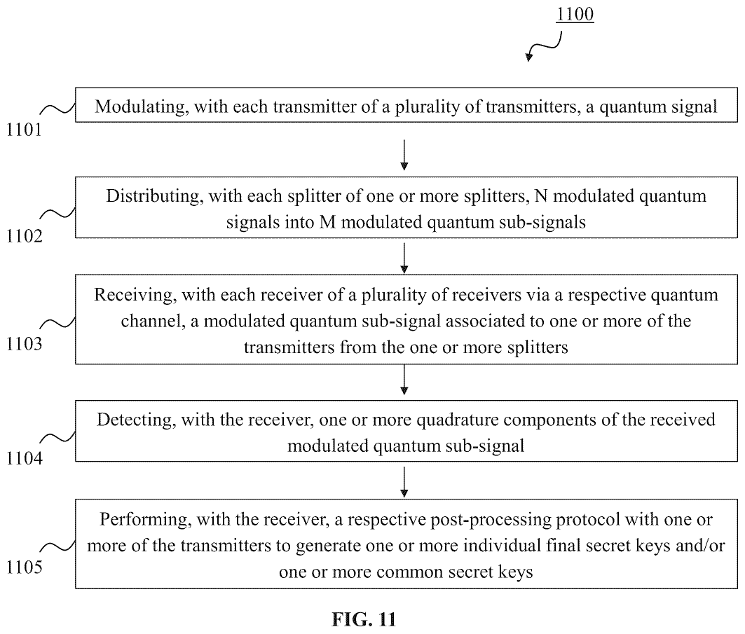

FIG. 11 shows an exemplary embodiment of a method 1100 for a CV-QKD system 100. The method 1100 may be carried out by the different exemplary embodiments of the CV-QKD system 100 described above and shown in FIG. 1, FIG. 2, FIG. 3, FIG. 4, FIG. 5, FIG. 6, FIG. 7, FIG. 8, FIG. 9 and FIG. 10.

The method 1100 comprises a step 1101 of modulating, with each transmitter 110 of a plurality of transmitters 110, a quantum signal according to a discrete or continuous distribution in phase and amplitude.

Then, the method 1100 comprises a step 1102 of distributing, with each splitter 130 of one or more splitters 130, N modulated quantum signals into M modulated quantum sub-signals, where N≥1 and M≥2 or where N≥2 and M≥1, and where at least some of the N modulated quantum signals are received by each splitter 130 from a respective transmitter 110 or from another splitter 130.

The method 1100 further comprises a step 1103 of receiving, with each receiver 120 of a plurality of receivers 120 via a respective quantum channel, a modulated quantum sub-signal associated to one or more of the plurality of transmitters 110 from the one or more splitters 130.

Next, the method 1100 comprises a step 1104 of detecting, with the receiver 120, one or more quadrature components of the received modulated quantum sub-signal.

The method 1100 further comprises a step 1105 of performing, with the receiver 120, a respective post-processing protocol with one or more of the plurality of transmitters 110 to generate one or more individual final secret keys between the one or more transmitters 110 and the receiver 120 based on the detected one or more quadrature components and/or one or more common secret keys between the one or more transmitters 110 and the plurality of receivers 120 based on the detected one or more quadrature components.

The method 1100 may further comprise actions according to the described aforementioned embodiments of the CV-QKD system 100 and its implementation forms. Hence, the method 1100 achieves the same advantages as the CV-QKD system 100.

The present disclosure further provides a computer program comprising instructions that, when the program is executed by a computer, cause the computer to carry out the method 1100 shown in FIG. 11.

The computer program may be included in a computer readable medium. The computer readable medium may comprise essentially any memory, such as a ROM (Read-Only Memory), a PROM (Programmable Read-Only Memory), a 15 EPROM (Erasable PROM), a Flash memory, an EEPROM (Electrically Erasable PROM), or a hard disk drive.

The computer program achieves the same advantages as the method 1100 and as the CV-QKD system 100 and their implementation forms.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfil the functions of several entities or items recited in the claims. The mere fact that certain measures are recited in the mutual different dependent claims does not indicate that a combination of these measures cannot be used in an advantageous implementation.

What is claimed is:

1. A system, comprising:
a plurality of transmitters, each transmitter being configured to modulate a quantum signal according to a discrete or continuous distribution in phase and amplitude;
one or more splitters, each splitter being configured to:
distribute N modulated quantum signals into M modulated quantum sub-signals, wherein N≥1 and M≥2 or wherein N≥2 and M≥1, and wherein at least some of the N modulated quantum signals are received by each splitter from a respective transmitter or from another splitter; and
a plurality of receivers, each receiver being configured to:
receive, via a respective quantum channel, a modulated quantum sub-signal associated to one or more of the plurality of transmitters from the one or more splitters;
detect one or more quadrature components of the received modulated quantum sub-signal; and
perform a respective post-processing protocol with one or more of the plurality of transmitters to generate one or more individual final secret keys between the one or more transmitters and the receiver or one or more common secret keys between the one or more transmitters and the plurality of receivers based on the detected one or more quadrature components.

2. The system according to claim 1, wherein each splitter is a passive optical splitter.

3. The system according to claim 1, wherein each splitter comprises a plurality of N×M ports, wherein N≥1 and M≥2 or wherein N≥2 and M≥1, and each of the N×M ports are configured to act simultaneously as an input port and as an output port.

4. The system according to claim 1, wherein each splitter is further configured to:
receive the N modulated quantum signals transmitted by a respective transmitter; or
provide one or more of the M modulated quantum sub-signals to a respective receiver or to another splitter.

5. The system according to claim 1, wherein one or more of the N×M ports of each splitter is further coupled to a circulating circuit, the circulating circuit being configured to provide a modulated quantum sub-signal received from the one or more ports to one of the plurality of receivers or to another splitter.

6. The system according to claim 1, further comprising:
one or more optical switches, each optical switch being configured to:
receive one or more modulated quantum signals from a respective transmitter or one or more modulated quantum sub-signals from one or more of the one or more splitters; and
direct each received modulated quantum signals or each received modulated quantum sub-signal to one of the plurality of receivers or to another splitter.

7. The system according to claim 1, wherein each transmitter is further configured to transmit a synchronization signal to one or more of the plurality of receivers through the one or more splitters.

8. The system according to claim 7, wherein each transmitter is further configured to transmit the synchronization signal together with the modulated quantum signal.

9. The system according to claim 1, wherein at least two receivers receive a respective modulated quantum sub-signal associated to at least one of the transmitters from the one or more splitters; and
wherein the respective post-processing protocol to generate one or more individual final secret keys comprises:
the at least one of the transmitters and a first receiver generate a first individual final secret key between them by performing a first quantum key distribution (QKD) post-processing, wherein a part of the modulated quantum signal from the at least one of the transmitters distributed by the one or more splitters into the respective modulated quantum sub-signal that is received by a second receiver is considered to be lost to an eavesdropper; and
the at least one of the transmitters and the second receiver generate a second individual final secret key between them by performing a second QKD post-processing, wherein a part of the modulated quantum signal from the at least one of the transmitters distributed by the one or more splitters into the respective modulated quantum sub-signal that is received by the first receiver is considered to be lost to the eavesdropper.

10. The system according to claim 1, wherein at least two receivers receive a respective modulated quantum sub-signal associated to at least one of the transmitters from the one or more splitters; and
wherein the respective post-processing protocol to generate one or more individual final secret keys comprises:
each of a first receiver and a second receiver sends to the at least one of the transmitters one or more respective data samples taken from the respective received modulated quantum sub-signal;
the at least one of the transmitters collectively estimates a first quantum channel of the first receiver and a second quantum channel of the second receiver;
the at least one of the transmitters and the first receiver generate a first individual final secret key between them by performing a third quantum key distribution (QKD) post-processing on the estimated first quantum channel; and
the at least one of the transmitters and the second receiver generate a second individual final secret key between them by performing a fourth QKD post-processing on the estimated second quantum channel.

11. The system according to claim 10, wherein the respective post-processing protocol to generate one or more common final secret keys comprises:
after each transmitter collectively estimates the first quantum channel of the first receiver and the second quantum channel of the second receiver, the at least one of the transmitters and each of the at least two receivers perform forward information reconciliation and establish a common key between the at least one of the transmitters and the at least two receivers; and
the at least one of the transmitters and the at least two receivers distill a final common secret key by using a post-selection method.

12. The system according to claim 1, wherein each of at least two receivers receives a respective modulated quantum sub-signal associated to at least two transmitters from the one or more splitters; and
wherein, the respective post-processing protocol to generate one or more individual final secret keys comprises:
each transmitter and a first receiver generate a respective individual final secret key between the respective transmitter and the first receiver by performing a respective quantum key distribution (QKD) post-processing, wherein a part of the modulated quantum signal transmitted from each transmitter and distributed by the one or more splitters that is received by the second receiver in the respective modulated quantum sub-signal is considered to be lost to an eavesdropper; and
each transmitter and a second receiver generate a respective individual final secret key between the respective transmitter and the second receiver by performing a respective QKD post-processing, wherein a part of the modulated quantum signal transmitted from each transmitter and distributed by the one or more splitters that is received by the first receiver in the respective modulated quantum sub-signal is considered to be lost to an eavesdropper.

13. The system according to claim 12, wherein each of at least two receivers receives a respective modulated quantum sub-signal associated to at least two transmitters from the one or more splitters; and
wherein the respective post-processing protocol to generate one or more individual final secret keys comprises:
each receiver sends to each transmitter, via a respective secure classical channel, one or more respective data samples from the respective modulated quantum sub-signal;
each transmitter collectively estimates a first quantum channel of the first receiver and a second quantum channel of the second receiver;
each transmitter and the first receiver generate a respective individual final secret key between the respective transmitter and the first receiver by performing a respective quantum key distribution (QKD) post-processing on the respective estimated first quantum channel; and
each transmitter and the second receiver generate a respective individual final secret key between the respective transmitter and the second receiver by performing a respective QKD post-processing on the respective estimated second quantum channel; and
wherein the at least two transmitters transmit the respective modulated quantum signal through the one or more splitters using time multiplexing.

14. The system according to claim 1, wherein at least one receiver receives a respective modulated quantum sub-signal associated to at least two transmitters from the one or more splitters, the at least two transmitters transmitting the respective modulated quantum signal through the one or more splitters using time multiplexing; and
wherein the respective post-processing protocol to generate one or more individual final secret keys comprises:
the at least one receiver receives the respective modulated quantum sub-signal associated to each of the at least two transmitters from the one or more splitters at a different time; and
each transmitter and the at least one receiver perform a respective quantum key distribution (QKD) post-processing to generate a respective individual final secret final key between each transmitter and the at least one receiver.

15. The system according to claim 1, wherein at least one receiver receives a respective modulated quantum sub-signal associated to at least two transmitters from the one or more splitters, the at least two transmitters transmitting the respective modulated quantum signal through the one or more splitters using frequency multiplexing; and
wherein the respective post-processing protocol to generate one or more individual final secret keys comprises:
the at least one receiver receives the respective quantum sub-signal associated to each of the at least two transmitters at a different frequency; and
each transmitter and the at least one receiver perform a respective quantum key distribution (QKD) post-processing to generate a respective individual final secret key between each transmitter and the at least one receiver.

16. The system according to claim 1, wherein at least one receiver receives a respective modulated quantum sub-signal associated to at least two transmitters from the one or more splitters; and
wherein the respective post-processing protocol to generate one or more individual final secret keys comprises:
the at least one receiver receives from the one or more splitters a combined signal, the combined signal comprising the respective modulated quantum sub-signals associated to the at least two transmitters received by the at least one receiver at a same time or at a same frequency or at a same polarization;
the at least one receiver announces the combined signal to the at least two transmitters via a respective classical secure channel; and
the at least two transmitters perform a respective quantum key distribution (QKD) post-processing to generate an individual final secret key between them.

17. The system according to claim 1, wherein at least one receiver receives a respective modulated quantum sub-signal associated to at least two transmitters from the one or more splitters; and
wherein the respective post-processing protocol to generate one or more individual final secret keys comprises:
a first transmitter announces its respective modulated quantum signal to a second transmitter and to the at least one receiver via a respective classical secure channel;
the at least one receiver determines a signal comprising a noisy version of the modulated quantum sub-signal associated to the second transmitter received from the one or more splitters; and
the second transmitter and the at least one receiver perform a respective QKD post-processing to generate an individual final secret key between them.

18. The system according to claim 9, wherein the respective post-processing protocol to generate one or more common final secret keys comprises:
the at least one of the transmitters generates a random string having a length equal to a length of the first individual final secret key between the at least one of the transmitters and the first receiver;
the at least one of the transmitters generates a first encrypted string by encrypting the random string using the first individual final secret key, and generates a second encrypted string by encrypting the random string using the second individual final secret key;
the at least one of the transmitters sends the first encrypted string to the first receiver and the second encrypted string to the second receiver; and
each of the first receiver and the second receiver obtains a respective final common secret key between the at least one of the transmitters and the at least two receivers by decrypting the respective received first encrypted string and the second encrypted string, the final common secret key comprising the random string generated by the transmitter.

19. The system according to claim 9, wherein the respective post-processing protocol to generate one or more common final secret keys further comprises:
the at least one of the transmitters generates an encrypted string by encrypting the first individual final secret key using the second individual final secret key;
the at least one of the transmitters sends the encrypted string to the second receiver; and
the second receiver obtains a final common key between the at least one of the transmitters and the at least two receivers by decrypting the received encrypted string using the second individual final secret key and extracting the first individual final secret key from the decrypted encrypted string, the final common key between the transmitter and the at least two receivers comprising the first individual final secret key.

20. The system according to claim 1, wherein the plurality of transmitters, the plurality of receivers and the one or more splitters are arranged forming a plurality of transmitting nodes and a plurality of receiving nodes, each transmitting node comprising one transmitter connected to a first splitter, and each receiving node comprising one receiver connected to a second splitter;
wherein the plurality of transmitting nodes and the plurality of receiving nodes are arranged in an alternating manner, so that each transmitting node has a neighbour receiving node, and each transmitting node and each neighbour receiving node share the respective transmitter and the respective receiver;
wherein the first splitter of each transmitting node receives a modulated quantum signal from the respective transmitter, and the second splitter of each receiving node receives a modulated quantum sub-signal from the respective first splitter of two of the transmitting nodes; and
wherein the receiver of each receiving node receives a modulated quantum sub-signal associated to two respective transmitters of two neighbouring transmitting nodes from the respective second splitter.
